(19) United States
(12) Patent Application Publication
(10) Pub. No.: US 2016/0253468 A1
(43) Pub. Date: Sep. 1, 2016

(54) MEASUREMENT VALUE MANAGEMENT APPARATUS, METHOD FOR OPERATING MEASUREMENT VALUE MANAGEMENT APPARATUS, AND MEASUREMENT VALUE MANAGEMENT SYSTEM

(71) Applicant: FUJIFILM Corporation, Tokyo (JP)

(72) Inventor: Akira OSAWA, Kanagawa (JP)

(73) Assignee: FUJIFILM Corporation, Tokyo (JP)

(21) Appl. No.: 15/054,152

(22) Filed: Feb. 26, 2016

(30) Foreign Application Priority Data
Feb. 27, 2015 (JP) 2015-038327

(51) Int. Cl. G06F 19/00

(52) U.S. Cl. CPC G06F 19/345; G06F 19/321

(57) ABSTRACT

A determination unit calculates an absolute value of a difference between an average value of measurement values registered in a measurement value list of a measurement database and a measurement value received by a registration request receiver, as a reliability index. The determination unit compares magnitude of the reliability index and that of standard deviation of the measurement values registered in the measurement value list. The determination unit determines that the measurement value received by the registration request receiver is reliable in a case where the reliability index<the standard deviation and determines that the measurement value received by the registration request receiver is unreliable in a case where the reliability index≧the standard deviation. A registration unit registers the measurement value received by the registration request receiver in association with a result of the determination in the measurement value list.

### CROSS-REFERENCE TO RELATED APPLICATIONS

The present application claims priority under 35 U.S.C. §119 to Japanese Patent Application No. 2015-038327, filed Feb. 27, 2015. Each of the above applications is hereby expressly incorporated by reference, in its entirety, into the present application.

### BACKGROUND OF THE INVENTION

1. Field of the Invention

The present invention relates to a measurement value management apparatus, a method for operating a measurement value management apparatus, and a measurement value management system for managing a measurement value representing a feature of a lesion in an examination image.

2. Description Related to the Prior Art

Imaging examinations are widely performed in medical fields. In the imaging examination, examination images of a patient are captured with a modality such as a CT (Computed tomography) device or an MRI (Magnetic Resonance Imaging) device. In the imaging examination, a measurement value that represents a feature of a lesion in the examination image is measured or calculated.

For example, Japanese patent No. 5094775 describes a technique to extract a lesion region from each of past case images and the examination image of the patient of interest and to calculate the measurement value with respect to each of the extracted lesion regions, to retrieve the past case image similar to the examination image of the patient of interest. Examples of the measurement values include those related to pixel values (e.g. average value, variance, maximum value, and minimum value of the pixel values) in the lesion region, those related to the shape (e.g. position and circularity of the contour) of the lesion region, and those related to the size (e.g. radius, area, and volume) of the lesion region.

The Japanese patent No. 5094775 describes a method for manually extracting the lesion region by a measurer (e.g. through designating position coordinates of the lesion region by the measurer) and a method for automatically extracting the lesion region with a program exclusively used for the measurement.

In the imaging examination, the measurements of the measurement values may be performed two or more times with respect to the same lesion in the same examination image. Examples of such measurements include those performed by two or more measurers (e.g. a radiologist who captures the examination image and prepares a medical report and a clinician who consults and treats the patient), those performed by one measurer on different examination dates, those performed by the measurer manually extracting the lesion region and calculating the measurement value and also by a measurement program automatically extracting the lesion region and calculating the measurement value, those performed by different measurement programs operated at the same time to automatically and individually extract the lesion region and calculate the measurement value, and those performed by different measurement programs calculating the measurement values with respect to the same region.

The two or more measurements performed with respect to the same lesion (or lesion region) in the same examination image provide two or more measurement values with respect to the lesion. There is a possibility that the measurement values include those with little or no reliability, which are worthless as a reference for consultation or statistical analysis. This is because the extracted lesion regions may vary due to an error of the measurer or due to variations among the measurers, or the measurement program that extracts the lesion region with low accuracy or calculates the measurement value with low accuracy may be used for the measurements.

In the case where the measurement values include unreliable ones, which are not identified, the measurement value to be used cannot be determined. This makes it difficult to perform the consultation or treatment (e.g. determining the effect of the surgery or medication through chronological changes in the measurement values) based on the measurement values or to perform the statistical analysis to analyze the effect of the medication. For this reason, a mechanism that enables easy reference to a reliable measurement value to be used for the consultation, the treatment, or the statistical analysis is needed in the case where the two or more measurements are performed with respect to the same lesion in the same examination image.

### SUMMARY OF THE INVENTION

An object of the present invention is to provide a measurement value management apparatus, a method for operating a measurement value management apparatus, and a measurement value management system that enable easy reference to a reliable measurement value to be used for consultation, treatment, or statistical analysis in a case where a measurement value that represents a feature of a lesion is measured two or more times with respect to the same lesion in an examination image.

In order to achieve the above and other objects, an aspect of the present invention provides a measurement value management apparatus comprising a determination unit and a registration unit. The determination unit is configured to perform determination of presence or absence of reliability of two or more measurement values obtained by two or more measurements of the measurement values with respect to a lesion in an examination image. The measurement value represents a feature of the lesion. The registration unit is configured to register the measurement value in association with a result of the determination in a data storage unit.

It is preferred that the determination unit calculates a reliability index and performs the determination based on a result of a comparison between the reliability index and a threshold value. The reliability index quantitatively represents the reliability of each of the measurement values. In this case, it is preferred that the determination unit calculates the reliability index based on an average value of the measurement values. It is preferred that the measurement value management apparatus further comprises a setting unit configured to set the threshold value based on standard deviation of the measurement values.

It is preferred that the determination unit determines that the measurement values are unreliable in a case where the number of the measurement values is less than a predetermined lower limit number.

It is preferred that the registration unit registers measurer-related information in association with the measurement values and the results of the determination. The measurer-related information is information related to a measurer, who or which performed the measurement. It is preferred that the determination unit excludes the measurement value measured by the measurer whose percentage of the measurement values determined to be unreliable is higher than or equal to a predetermined upper limit value and calculates the reliability index. It is preferred that the determination unit reduces a percentage of contribution of the measurement value, measured by the measurer whose percentage of the measurement values determined to be unreliable is higher than or equal to the predetermined upper limit value, to the calculation of the reliability index.

It is preferred that the measurer-related information includes at least one of measurer identification information for identifying the measurer, measurement apparatus identification information for identifying a measurement apparatus that performed the measurement, or measurement program identification information for identifying a measurement program that performed the measurement.

It is preferred that the measurement value management apparatus further comprises an output unit configured to output the measurement value and the result of the determination. In this case, it is preferred to generate a list display screen. It is preferred that the list display screen displays the measurement values and the results of the determination in a list. It is preferred that the list display screen displays a graph based on the measurement values that are determined to be reliable by the determination unit. The graph shows chronological changes in the measurement values.

It is preferred that the output unit outputs medical data of a patient in addition to the measurement values. In this case, it is preferred to generate an integrated display screen. It is preferred that the integrated display screen displays the measurement values and the medical data. It is preferred that the integrated display screen displays a graph based on the measurement values that are determined to be reliable by the determination unit. The graph shows chronological changes in the measurement values.

It is preferred that the determination unit acquires definitive diagnosis information of the lesion. It is preferred that the determination unit performs the determination before the acquisition of the definitive diagnosis information and redetermines the determination based on the definitive diagnosis information after the acquisition of the definitive diagnosis information.

It is preferred that a warning that the determination has been changed is informed in a case where the measurement value determined to be unreliable by the determination made before the acquisition of the definitive diagnosis information is redetermined to be reliable by the determination made after the acquisition of the definitive diagnosis information.

It is preferred that the measurement value includes size-related measurement value. The size-related measurement value is related to the size of a region of the lesion.

An aspect of the present invention provides a method for operating a measurement value management apparatus comprising a determination step and a registration step. The determination step determines presence or absence of reliability of two or more measurement values obtained by two or more measurements of the measurement values with respect to a lesion in an examination image. The measurement value represents a feature of the lesion. The registration step registers the measurement value in association with a result of the determination, which is obtained by the determination step, in a data storage unit.

An aspect of the present invention provides a measurement value management system comprising a measurement apparatus and a measurement value management apparatus. The measurement apparatus performs measurement of a measurement value with respect to a lesion in an examination image. The measurement value management apparatus manages the measurement value. The measurement value represents a feature of the lesion. The measurement value management system comprises a determination unit and a registration unit. The determination unit is configured to perform determination of presence or absence of reliability of the two or more measurement values obtained by the two or more measurements with respect to the lesion in the examination image. The registration unit is configured to register the measurement value in association with a result of the determination in a data storage unit.

According to the aspects of the present invention, the two or more measurement values with respect to the same lesion in the same examination image are obtained by the measurements performed two or more times. The measurement value represents the feature of the lesion. The presence or absence of the reliability is determined for each measurement value. The result of the determination and the measurement value are registered in association with each other in the data storage unit. Thereby the measurement value management apparatus, the method for operating the measurement value management apparatus, and the measurement value management system enable easy reference to a reliable measurement value to be used for consultation, treatment, or statistical analysis in a case where a measurement value that represents a feature of a lesion is measured two or more times with respect to the same lesion in an examination image.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 illustrates a medical information system;

FIG. 2 illustrates various information transmitted and received between a client terminal apparatus and a diagnosis support server apparatus;

FIG. 3 illustrates content of image-related information;

FIG. 4 illustrates content of measurer-related information;

FIG. 5 illustrates content of measurement information;

FIG. 6 illustrates content of an image list;

FIG. 7 illustrates content of an EMR list;

FIG. 8 illustrates content of a measurement value list;

FIG. 9 is a block diagram illustrating a computer constituting a client terminal apparatus or a diagnosis support server apparatus;

FIG. 10 is a block diagram illustrating functions of a CPU of the client terminal apparatus;

FIG. 11 illustrates a viewer screen;

FIG. 12 illustrates the viewer screen, on which the results of measurements are displayed;

FIG. 13 illustrates a delivery request screen;

FIG. 14 illustrates a block diagram illustrating functions of the CPU of the diagnosis support server apparatus;

FIG. 15 illustrates a lesion identification process performed by a lesion identifier;

FIG. 16 illustrates the lesion identification process performed by the lesion identifier;

FIG. 17 illustrates the lesion identification process performed by the lesion identifier;

FIG. 18 illustrates the lesion identification process performed by the lesion identifier;

FIG. 19 illustrates a process for setting a threshold value performed by a setting unit;

FIG. 20 illustrates a process for determining presence or absence of reliability of a measurement value performed by a determination unit;

FIG. 21 illustrates the process for determining the presence or absence of the reliability of the measurement value performed by the determination unit;

FIG. 22 illustrates a list display screen;

FIG. 23 illustrates a lesion ID manually corrected on a list display screen;

FIG. 24 illustrates an integrated display screen;

FIG. 25 illustrates an enlarged image of a lesion in the integrated display screen;

FIG. 26 is a flowchart illustrating a procedure of the CPU of the client terminal apparatus and a procedure of the CPU of the diagnosis support server apparatus;

FIG. 27 is a flowchart illustrating a procedure of the CPU of the client terminal apparatus and a procedure of the CPU of the diagnosis support server apparatus;

FIG. 28 illustrates a process for determining the presence or absence of reliability of a measurement value performed by the determination unit according to a second embodiment;

FIG. 29 is a list showing the total number of times of the measurements of the measurement values, the number of NGs, and the percentage of NGs for each staff ID;

FIG. 30 illustrates a process for determining the presence or absence of reliability of the measurement values performed by the determination unit according to a third embodiment;

FIG. 31 illustrates a process for determining the presence or absence of the reliability of the measurement values performed by the determination unit according to the third embodiment;

FIG. 32 illustrates a process for determining the presence or absence of the reliability of the measurement values performed by the determination unit according to a fourth embodiment;

FIG. 33 illustrates a measurement value list in which the measurement values are stored in association with results of the determination made before acquisition of definitive diagnosis information and results of the determination made after the acquisition of the definitive diagnosis information; and

FIG. 34 illustrates an example of a warning display in the case where the determination is changed from NG (no good or unreliable) to OK (reliable) after the acquisition of the definitive diagnosis information.

### DESCRIPTION OF THE PREFERRED EMBODIMENTS

### First Embodiment

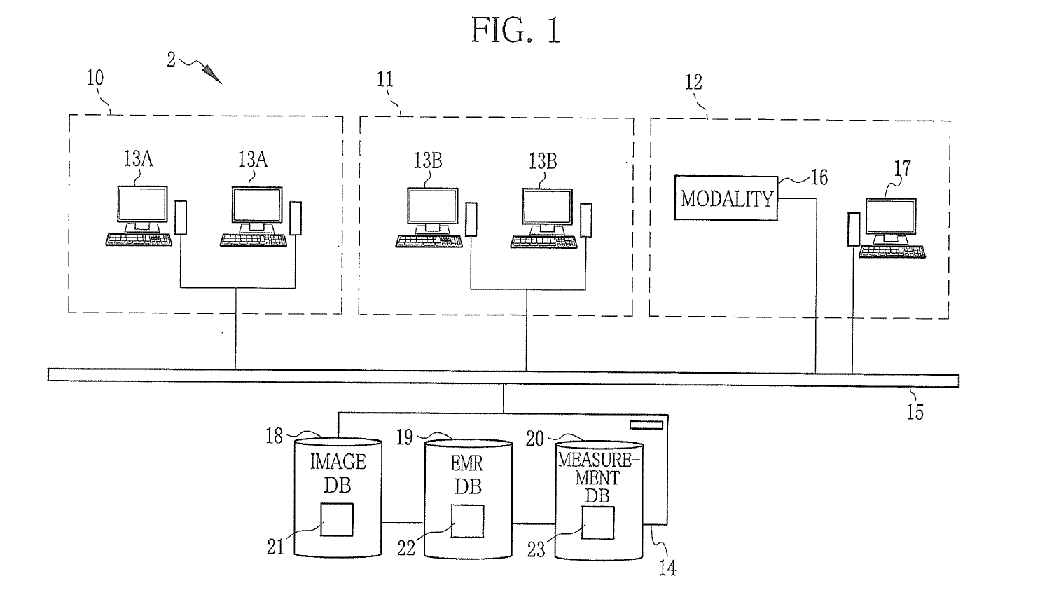

In FIG. 1, a medical information system 2, which is an example of a measurement value management system, is constructed in a medical facility. The medical facility comprises a clinical department 10, an interpretation department 11, an examination department 12, and the like. The medical information system 2 comprises a clinical department terminal apparatus 13A, an interpretation department terminal apparatus 13B, and a diagnosis support server apparatus 14, which are interconnected through a network 15 such as a LAN (Local area network) or the like constructed in the medical facility. The clinical department terminal apparatus 13A and the interpretation department terminal apparatus 13B are examples of a measurement apparatus. The diagnosis support server apparatus 14 is an example of a measurement value management apparatus. The clinical department terminal apparatus 13A is disposed in the clinical department 10. The interpretation department terminal apparatus 13B is disposed in the interpretation department 11. Hereinafter, a client terminal apparatus 13 refers to the clinical department terminal apparatus 13A and the interpretation department terminal apparatus 13B altogether.

Each of the client terminal apparatus 13 and the diagnosis support server apparatus 14 is comprised of a computer (e.g. a personal computer, a server computer, a work station, or the like). The computer is installed with a control program (e.g. an operating system, or the like) and various types of application programs (e.g. a client program, a server program, or the like).

The diagnosis support server apparatus 14 has various functions, e.g. an image management function to manage examination images (hereinafter may simply referred to as the images), an EMR (electronic medical record) management function to manage EMRs, a measurement value management function to manage measurement values (or calculated values), and a diagnostic support information providing function to provide diagnostic support information. The measurement value (or calculated value) represents a feature of a lesion in the examination image. The diagnostic support information supports diagnosis of a patient. A medical staff (e.g. a clinician of the clinical department 10, a radiologist of the interpretation department 11, or the like) of the medical facility operates the client terminal apparatus 13 to utilize the various functions of the diagnosis support server apparatus 14 in diagnosing the patient. The clinician consults and treats the patient. The radiologist interprets the examination image to prepare a medical report. The medical staff is an example of a measurer.

In the examination department 12, a modality 16 and an examination department terminal apparatus 17 are disposed. Examples of the modalities 16 include CT (computed radiography) devices, MRI (magnetic resonance imaging) devices, general X-ray imaging devices, endoscopic devices, ultrasound imaging devices, PET (positron emission tomography) devices, and pathological test devices. The CT devices and the MRI devices capture tomographic images as the examination images. The general X-ray imaging devices capture plain X-ray images as the examination images. The general X-ray imaging devices include CR (computed radiography) devices, DR (digital radiography) devices, and breast imaging devices (including mammography devices). The endoscopic devices capture endoscopic images as the examination images. The ultrasound imaging devices capture ultrasonic images as the examination images. The PET devices capture PET images as the examination images. The pathological test devices capture pathological images as the examination images. A radiologic technologist, which is an example of the medical staff, of the examination department 12 operates the examination department terminal apparatus 17 to check an order for an imaging examination using the modality 16 or to check the examination image captured using the modality 16, for example.

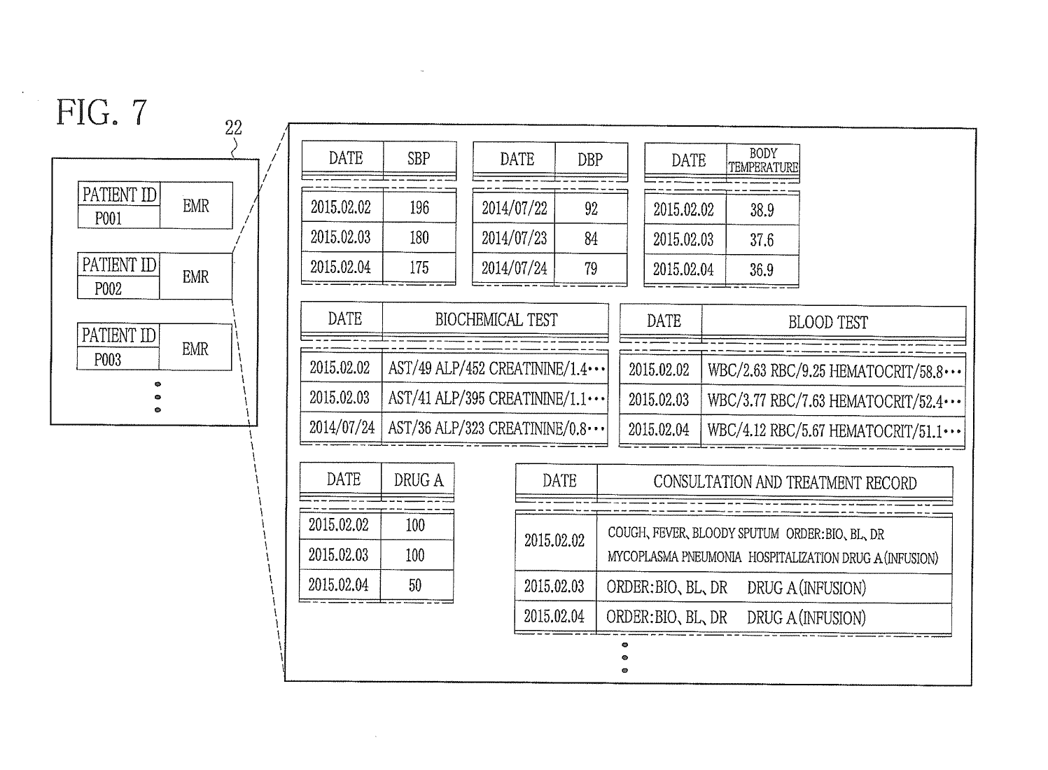

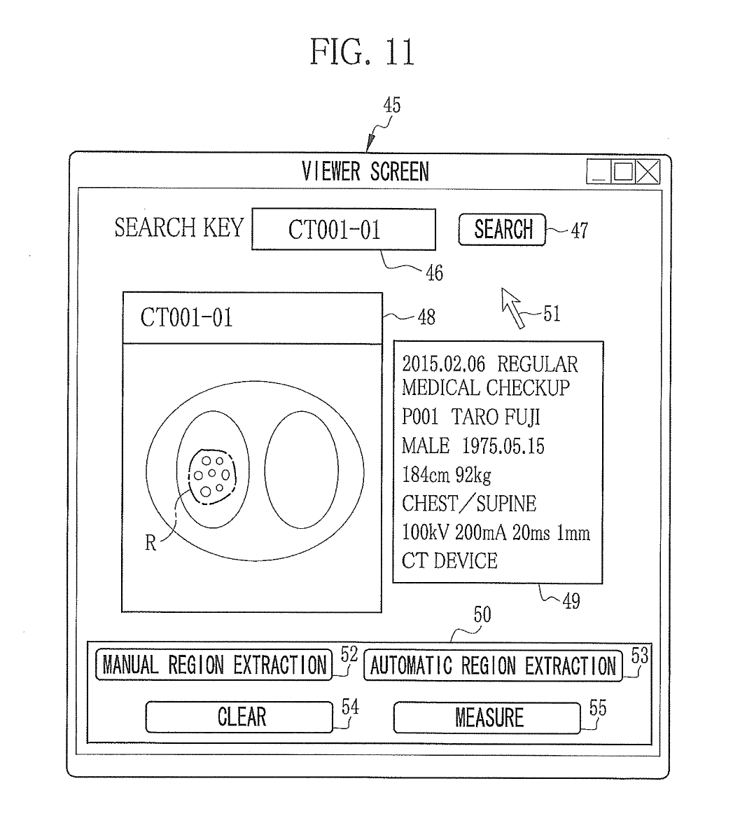

The clinician of the clinical department 10 or the radiologist of the interpretation department 11 operates the client terminal apparatus 13 to view the examination image, the EMR, or the diagnostic support information, or to input various medical data (see FIG. 7) to the EMR, or to extract a region R (see FIG. 11) of a lesion in the examination image and measure the measurement value, for example.

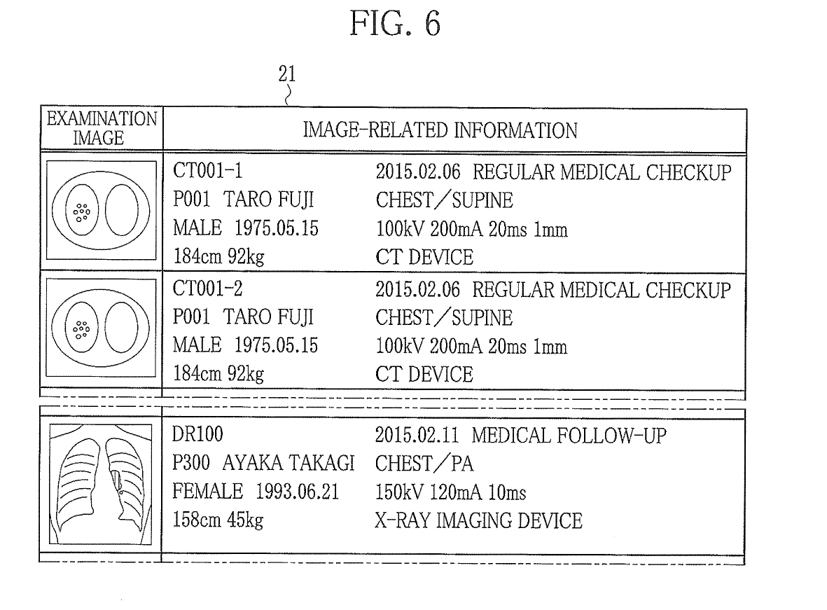

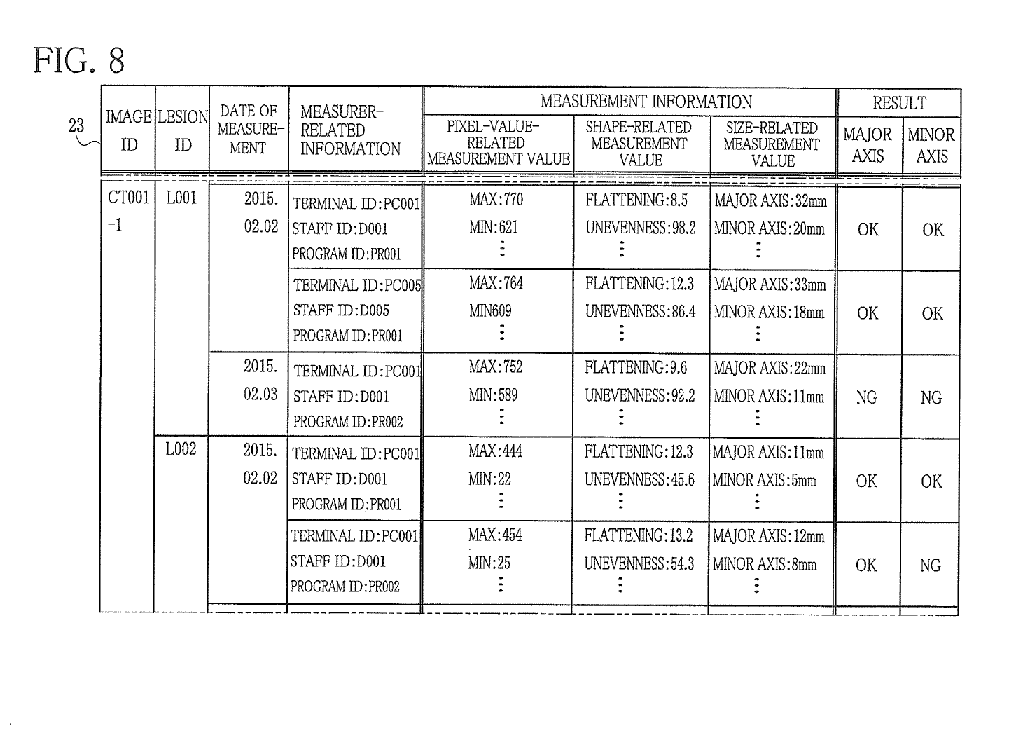

The diagnosis support server apparatus 14 is provided with an image database (DB) 18, an EMR DB 19, and a measurement DB 20. The measurement DB 20 is an example of a data storage unit. The image DB 18 stores an image list 21 (see FIG. 6). The EMR DB 19 stores an EMR list 22 (see FIG. 7). The measurement DB 20 stores a measurement value list 23 (see FIG. 8).

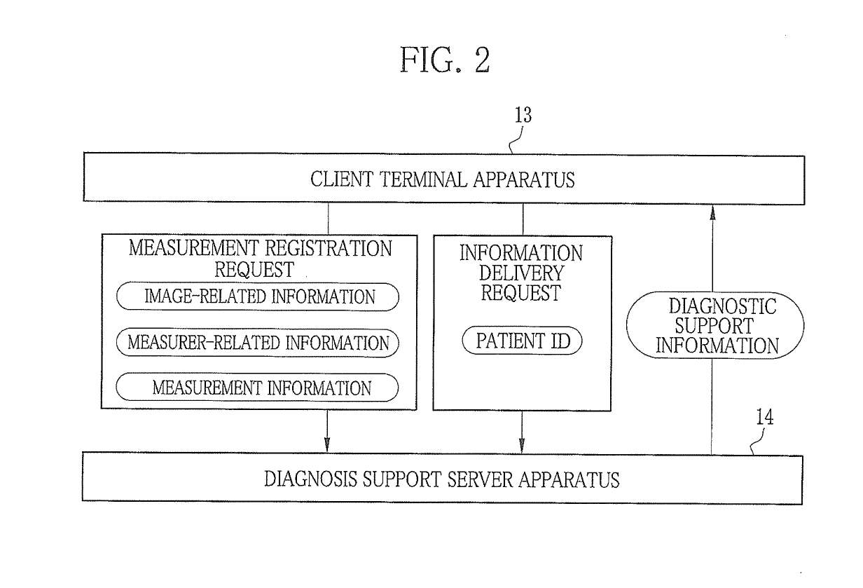

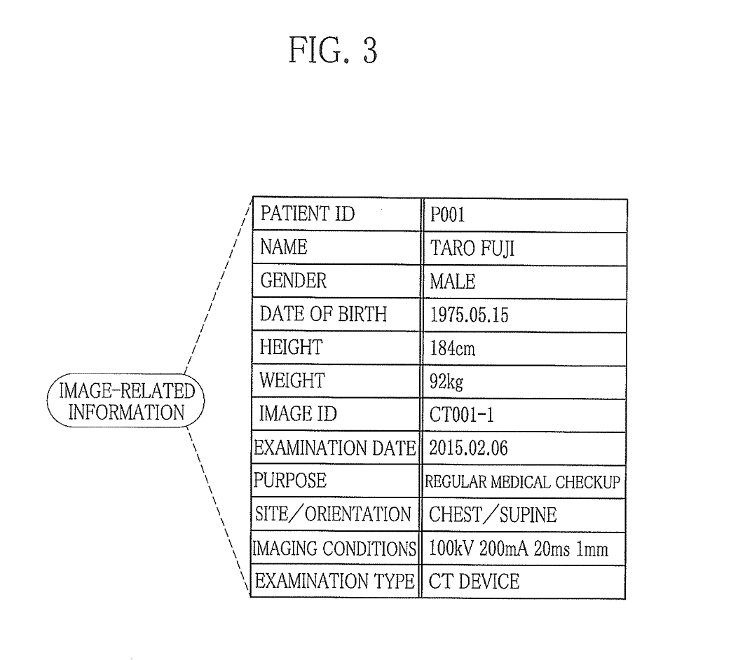

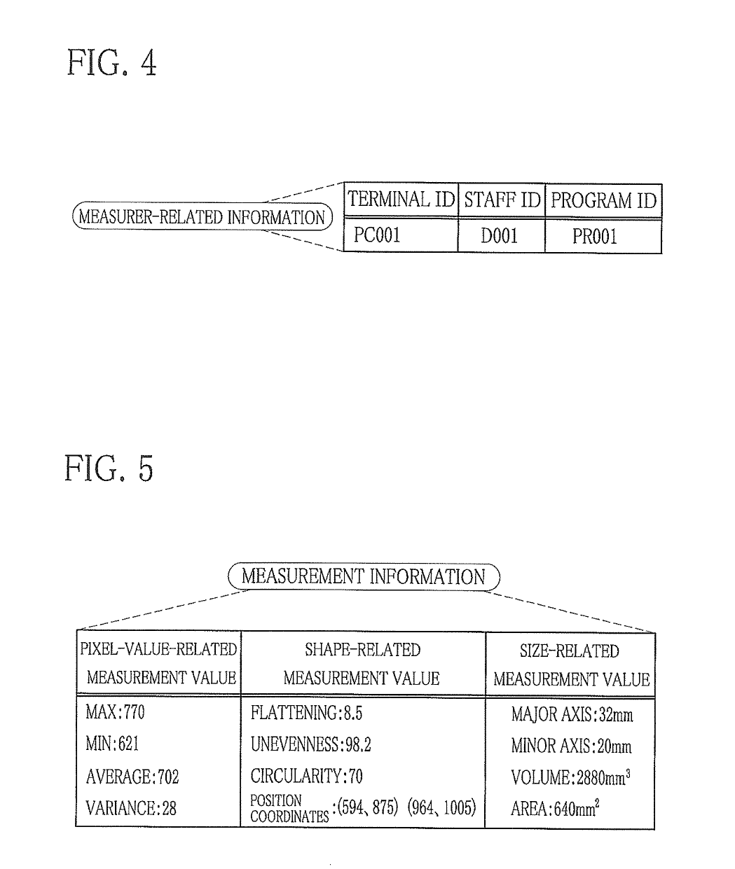

In FIG. 2, the client terminal apparatus 13 outputs a measurement registration request and an information delivery request to the diagnosis support server apparatus 14. The measurement registration request is a request for registration of the measurement value (or calculated value). The information delivery request is a request for delivery of the diagnostic support information. The measurement registration request includes (contains) image-related information (see FIG. 3), measurer-related information (see FIG. 4), and measurement information (see FIG. 5). The image-related information is information related to the examination image used for the measurement of the measurement value(s). The measurer-related information is information related to a measurer, which or who measured the measurement value(s). The measurement information is information related to the measurement value(s). The information delivery request includes (contains) a patient ID (identification data) for identifying a patient.

The diagnosis support server apparatus 14 receives each request from the client terminal apparatus 13. The diagnosis support server apparatus 14 registers an image ID (see FIG. 3) of the image-related information, the measurer-related information, and the measurement information, which are contained in the measurement registration request, to the measurement value list 23 and manages them. The diagnosis support server apparatus 14 generates the diagnostic support information of the patient with the patient ID contained in the information delivery request and provides the client terminal apparatus 13, which has sent the information delivery request, with the generated diagnostic support information.

Note that, in addition to the measurement registration request, the client terminal apparatus 13 outputs an image registration request for registration of the examination image and an EMR registration request for registration of the EMR (both not shown) to the diagnosis support server apparatus 14. In addition to the information delivery request, the client terminal apparatus 13 outputs an image delivery request for delivery of the examination image and an EMR delivery request for delivery of the EMR (both not shown) to the diagnosis support server apparatus 14. The diagnosis support server apparatus 14 registers the examination image, the registration of which has been requested by the image registration request, in the image list 21 and registers the EMR, the registration of which has been requested by the EMR registration request, in the EMR list 22 and manages them. The diagnosis support server apparatus 14 retrieves the examination image that is specified by the image delivery request from the image list 21, and retrieves the EMR that is specified by the EMR delivery request from the EMR list 22, and provides the client terminal apparatus 13, which has sent the image delivery request and the EMR delivery request, with the retrieved examination image and the retrieved EMR.

In FIG. 3, the image-related information comprises items (e.g. patient ID, name, gender, date of birth, height, and weight) for patient information and items (e.g. image ID, examination date, purpose of examination, body site to be examined and orientation, imaging conditions set to the modality 16, and examination type (that is, the type of modality 16 such as CT, MRI, and the like)) for examination. In the item “purpose of examination (which is abbreviated as “purpose” in the drawing)”, a regular medical checkup, a medical follow-up, or the like is recorded. In the item “body site to be examined and orientation (which is abbreviated as “site/orientation” in the drawing)”, a body site (e.g. head, chest, abdomen, leg, arm, hand, or the like) and an orientation of a patient (e.g. supine, prone, recumbent, frontal, lateral, PA (posterior-anterior), oblique, or the like, in other words, the direction of the incident radiation) are recorded. In the case where the examination image is produced as a data file conforming to DICOM (Digital Imaging and Communications in Medicine) standard, the image-related information is associated as tag information of the data file with the examination image.

The image ID is identification information for identifying the examination image and is automatically provided by the modality 16 at the time of capturing the examination image. Typically, in the general X-ray imaging, a plain X-ray image is captured in one imaging examination. In CT imaging and MRI imaging, on the other hand, two or more tomographic images are captured in one imaging examination. In the case where two or more examination images are captured in one imaging examination, a common image ID is provided to the examination images to indicate that these examination images are captured in the same imaging examination. The examination images with the common image ID are managed as a group. This applies the same to the case where two or more examination images are captured by the plain X-ray imaging in one imaging examination.

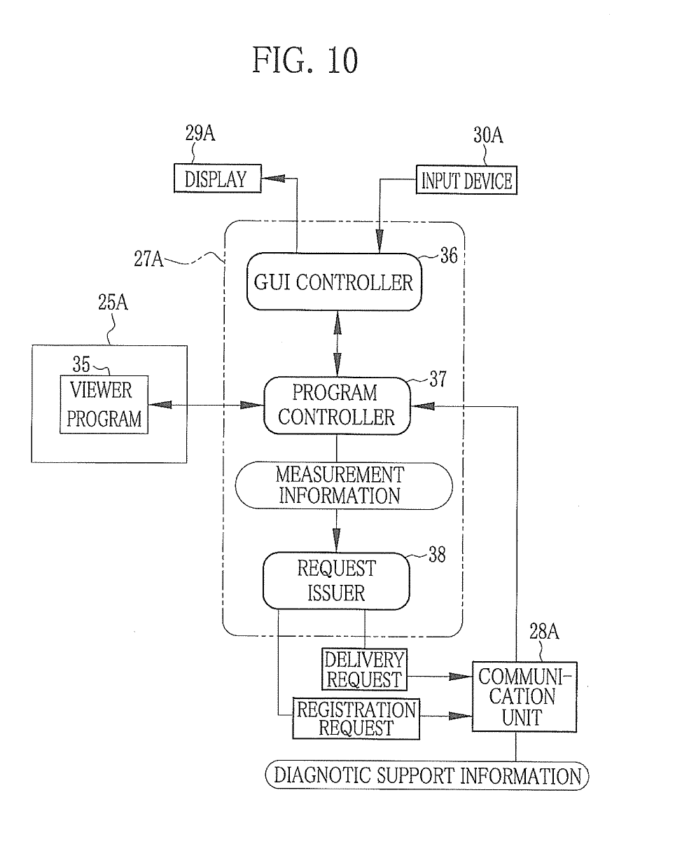

In FIG. 4, the measurer-related information comprises items such as a terminal ID, a staff ID, and a program ID. The terminal ID is identification information for identifying the client terminal apparatus 13. The staff ID is identification information for identifying the medical staff. The program ID is identification information for identifying a viewer program 35 (see FIG. 10), which runs on the client terminal apparatus 13. The viewer program 35 is an example of a measurement program.

The terminal ID is an example of measurement apparatus identification information for identifying the measurement apparatus that performed the measurement. The staff ID is an example of measurer identification information for identifying the measurer who performed the measurement. The program ID is an example of measurement program identification information for identifying the measurement program that performed the measurement. In the item “terminal ID”, the terminal ID of the client terminal apparatus 13 that sent the measurement registration request is recorded. In the item “staff ID”, the staff ID of the medical staff who logged on the client terminal apparatus 13 and measured the measurement value and sent the measurement registration request through the client terminal apparatus 13 is recorded. In the item “program ID”, the program ID of the viewer program 35 installed on the client terminal apparatus 13, which has sent the measurement registration request, and used for the measurement of the measurement values is recorded.

The terminal ID is, for example, a serial number or an IP (Internet protocol) address of the client terminal apparatus 13. The program ID is, for example, a serial number, the name of a program, version information, or the like of the viewer program 35.

In FIG. 5, the measurement information comprises items such as a pixel-value-related measurement value, a shape-related measurement value, and a size-related measurement value. The pixel-value-related measurement value is a measurement value related to pixel values in a region R of a lesion in the examination image. Examples of the pixel-value-related measurement values include a maximum value (abbreviated as MAX in the drawings), a minimum value (abbreviated as MIN in the drawings), an average value (hereinafter may simply referred to as the average), variance, and the like of the pixel values in the region R. The shape-related measurement value is a measurement value related to the shape of the region R. Examples of the shape-related measurement values include flattening, unevenness, circularity, position coordinates, and the like of the region R. The size-related measurement value is a measurement value related to the size of the region R. Examples of the size-related measurement values include a major axis length (may simply referred to as the major axis), a minor axis length (may simply referred to as the minor axis), the volume, the area, and the like of the region R.

In the item “position coordinates” of the shape-related measurement value, position coordinates representing the position of the region R in the examination image are recorded. The position coordinates represent the position of each pixel, which constitutes the examination image, in two-dimensions. For example, a pixel in the upper left corner is set as an origin point. In the case where the region R has a rectangular shape, the position coordinates of two points on a diagonal line of the rectangle (see FIG. 5) are recorded in the item “position coordinates”. Note that, in the case where the region R is a circle or has a circular shape, position coordinates of the center of the circle and a diameter (or a radius) are recorded in the item “position coordinates”. In the case whether the region R is an ellipse or has an oval shape, position coordinates of the center of the ellipse, a major axis, and a minor axis are recorded in the item “position coordinates”. In the case where the region R has an indefinite shape (see FIG. 11), the position coordinates of all the pixels located along the border of the region R are recorded in the item “position coordinates”. Note that a method for recording the position coordinates is not limited to the above. In the above-mentioned example, the position coordinates of all the pixels along the border of the region R are recorded in the case where the region R has the indefinite shape. Instead, the position coordinates of all the pixels located along the border of the region R, the major axis of the region R, and the minor axis of the region R may be recorded regardless of the shape of the region R.

In FIG. 6, the examination image is registered together with the image-related information in the image list 21. The examination image registered in the image list 21 is able to be searched for based on the image-related information.

In FIG. 7, the EMR is associated with the corresponding patient ID and registered on a patient-by-patient basis in the EMR list 22. The EMR registered in the EMR list 22 is able to be searched for based on the patient ID.

The EMR is comprised of various types of medical data. Examples of the medical data includes measurement data (e.g. vital signs such as blood pressure, body temperature, heart rate, pulse rate, and the like of the patient), examination data of medical examinations (e.g. a biochemical test, a laboratory test such as a blood test, and a physiological examination such as electroencephalogram), dose data of medication, and consultation and treatment data. The consultation and treatment data records, for example, description of consultation, description of treatment or therapy, diagnosis, orders for various medical examinations, and events (first consultation, patient transfer, hospital admission, surgery, hospital readmission, hospital discharge, or the like) throughout the medical process of the patient. The various types of medical data are registered chronologically with the dates (e.g. the date of the measurement, the date of the examination, the date of the medication, and the like).

FIG. 7 illustrates the measurement data of the vital signs (“SBP (systolic blood pressure)”, “DBP (diastolic blood pressure)”, and “body temperature”), the examination data of the medical examinations (“biochemical test” and “blood test”), and the dose data of the medication (“drug A”), by way of example. FIG. 7 also illustrates an example of the consultation and treatment data. Here, the consultation and treatment data shows the main complaint “fever” and the like obtained through diagnostic interview, the diagnosis “mycoplasma pneumonia”, orders for “the biochemical test (abbreviated as “BIO” in the drawing)”, “the blood test (abbreviated as “BL” in the drawing), and “plain radiography (abbreviated as “DR (digital radiography)” in the drawing).

In FIG. 8, the measurement value list 23 collectively stores the image ID of the image-related information, the measurer-related information, and the measurement information, which are contained in the measurement registration request, a lesion ID, dates of the measurements, and results (hereinafter may referred to as the determination results) of determination of presence or absence of reliability of the measurement values (for example, the measured (calculated) major and minor axis lengths) of the size-related measurement values, in association with each another. The measurement information and the determination result registered (stored) in the measurement value list 23 are able to be searched for based on the image ID, the lesion ID, the date of the measurement, or the measurer-related information.

The lesion ID is identification information for identifying a lesion in the examination image. Here, in the case where the examination images of the same body site of the same patient are captured using the same modality 16 on different dates for the purpose of, for example, a medical follow-up, the same lesion is located in substantially the same positions in the examination images captured. In this case, one lesion ID is given to the same lesion in the examination images of the same patient captured on the different dates.

In the case where two or more lesions are contained in one examination image, the image ID of the examination image is associated with two or more lesion IDs corresponding to the respective lesions (see, for example, the lesion IDs “L001” and “L002” in FIG. 8).

In the case where the client terminal apparatus 13 extracts the region R two or more times and measures (or calculates) the measurement values two or more times with respect to same lesion in the examination image or in the case where the client terminal apparatus 13 measures (or calculates) the measurement values two or more times with respect to the same region R extracted, two or more pieces of measurement information are registered for one lesion ID. For example, three pieces of measurement information are registered for the lesion ID “L001”. Two pieces of measurement information are registered for the lesion ID “L002”.

Of the three pieces of measurer-related information stored in association with the lesion ID “L001”, the terminal IDs (“PC001” and “PC005”) stored in the two pieces of measurer-related information corresponding to the date of measurement “2015.02.02” are different from each other. The staff IDs (“D001” and “D005”) stored in the two pieces of measurer-related information corresponding to the date of measurement “2015.02.02” are also different from each other. The terminal ID and the staff ID of the measurer-related information corresponding to the date of measurement “2015.02.03” are the same as those of the upper piece of the measurer-related information corresponding to the date of measurement “2015.02.02”, but the program ID “PR002” of the measurer-related information corresponding to the date of measurement “2015.02.03” is different from the program ID “PR001” of the upper piece of the measurer-related information corresponding to the date of measurement “2015.02.02”.

“The cases where the two or more extractions of the region R and the two or more measurements of the measurement values with respect to the region R are performed” include, for example, a case where the two or more measurers (e.g. the radiologist and the clinician) perform the extractions and the measurements, a case where the same measurer performs the extractions and the measurements on different dates, a case where the measurer manually extracts the region R and calculates the measurement value and the viewer program 35 automatically extracts the region R and calculates the measurement value, a case where the different viewer programs 35 are executed simultaneously and each of them automatically extracts the region R and calculates the measurement value, a case where the different viewer programs 35 are used for calculating the measurement values with respect to the one region R extracted, and the like.

In the item “determination result (which may be abbreviated as “result” in the drawings)”, “OK (meaning “reliable”)” is registered (recorded) in the case where the measurement value (or the calculated value) of the major axis length or the minor axis length is determined to be reliable and “NG (no good, meaning “unreliable”)” is registered (recorded) in the case where the measurement value (or the calculated value) of the major axis length or the minor axis length is determined to be unreliable.

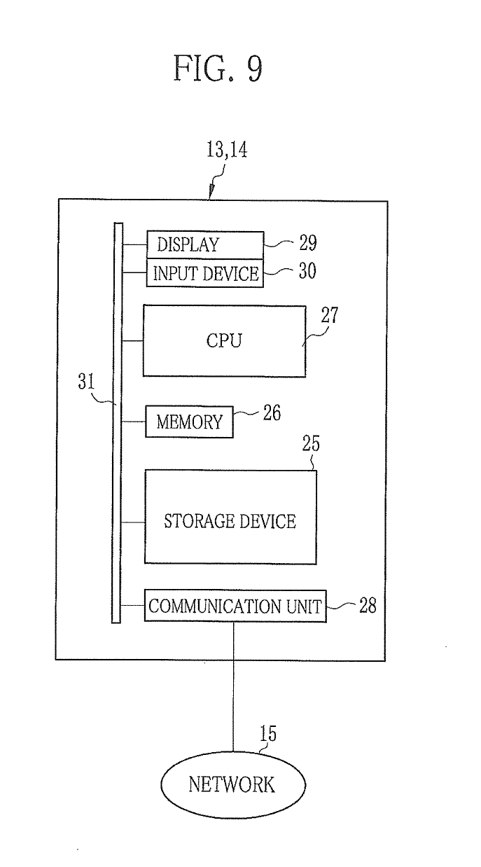

In FIG. 9, the basic configuration of the computer constituting the client terminal apparatus 13 is substantially the same as that of the computer constituting the diagnosis support server apparatus 14. Each computer comprises a storage device 25, a memory 26, a CPU (central processing unit) 27, a communication unit 28, a display 29, and an input device 30, which are interconnected through a data bus 31.

The storage device 25 may be incorporated in the computer that constitutes the client terminal apparatus 13, or the like. The storage device 25 may be a hard disk drive connected to the computer through a cable or a network. The storage device 25 may be a disk array composed of two or more hard disk drives connected. The storage device 25 stores a control program (e.g. operating system), various types of application programs, and display data of various types of operation screens associated with the programs.

The memory 26 is a working memory, which is used by the CPU 27 to execute processing. The CPU 27 loads the programs, which are stored in the storage device 25, into the memory 26 and executes the processing in accordance with the programs. Thereby the CPU 27 centrally controls each section of the computer.

The communication unit 28 is a network interface that controls transmissions of various types of information through the network 15. The display 29 displays the various types of operation screens in accordance with the operation of the input device 30 such as a mouse, a keyboard, or the like. The operation screen is provided with operation functions through a GUI (Graphical User Interface). A computer, which constitutes the client terminal apparatus 13 or the like, receives the input of an operation command from the input device 30 through the operation screen.

Note that, in the descriptions below, a suffix “A” is attached to a numeral that denotes a part of the computer that constitutes the client terminal apparatus 13 and a suffix “B” is attached to a numeral that denotes a part of the computer that constitutes the diagnosis support server apparatus 14.

In FIG. 10, a storage device 25A of the client terminal apparatus 13 stores the viewer program 35. The viewer program 35 is an application program that allows viewing the examination image, the EMR, and the diagnostic support information and allows outputting the requests and allows the extraction of the region R and the measurements of the measurement values.

Upon the start of the viewer program 35, a CPU 27A of the client terminal apparatus 13 works together with the memory 26, and thereby functions as a GUI controller 36, a program controller 37, and a request issuer 38.

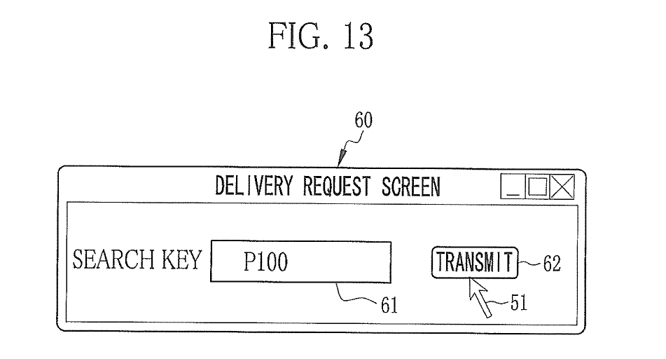

The GUI controller 36 displays an operation screen (e.g. a viewer screen 45 (see FIG. 11), a delivery request screen 60 (see FIG. 13), or the like) on a display 29A and receives an operation command inputted from an input device 30A through the operation screen. Examples of the operation commands include an image delivery command for delivery of the examination image, a region extraction command for extraction of the region R, a measurement command for measurement of the measurement value, a measurement registration command for registration of the measurement value (or the calculated value), and an information delivery command for delivery of the diagnostic support information. The GUI controller 36 outputs the received operation command to the program controller 37.

The program controller 37 controls the operation of the viewer program 35. The program controller 37 generates the operation screen (e.g. the viewer screen 45 or the like) and outputs the generated operation screen to the GUI controller 36.

The request issuer 38 issues each of the requests, for example, the measurement registration request for the registration of the measurement value (or the calculated value), the information delivery request for the delivery of the diagnostic support information, and the like. The request issuer 38 allows the communication unit 28 to output each request.

Upon receiving the region extraction command and the measurement command, the program controller 37 extracts the region R and calculates the measurement value with respect to the region R. Thereby the program controller 37 generates the measurement information. Upon receiving the measurement registration command, the program controller 37 outputs the generated measurement information to the request issuer 38.

Note that the storage device 25A (not shown) stores the terminal ID and the program ID of the measurer-related information necessary for issuing the measurement registration request. Upon receiving the measurement registration command, the program controller 37 allows the request issuer 38 to read the terminal ID and the program ID from the storage device 25A. The staff ID of the measurer-related information may be obtained by, for example, allowing the medical staff to input the staff ID, an authentication key, and the like through a startup screen of the viewer program 35.

In FIG. 11, the viewer screen 45 is provided with an input box 46, a search button 47, an image display area 48, an image-related information display area 49, and a button group 50.

The input box 46 and the search button 47 are provided to input the image delivery command. Immediately after the image-related information of the examination image (e.g. the image ID of the examination image to be displayed) is inputted to the input box 46 and then the search button 47 is selected with a cursor 51, the request issuer 38 issues the image delivery request for the delivery of the examination image.

The image display area 48 displays the examination image, which is transmitted from the diagnosis support server apparatus 14 in response to the image delivery request, and the image ID. The image-related information display area 49 displays the image-related information of the examination image displayed in the image display area 48.

A button group 50 comprises a manual region extraction button 52, an automatic region extraction button 53, a clear button 54, and a measurement button 55. The manual region extraction button 52, the automatic region extraction button 53, and the clear button 54 are provided for inputting the region extraction command for the extraction of the region R. The measurement button 55 is provided for inputting the measurement command for the measurement of the measurement value.

The manual region extraction button 52 is an operation button used by the medical staff to manually designate and extract the region R. Selecting the manual region extraction button 52 with the cursor 51 enables manually designating any region in the examination image. The region R is manually designated with the cursor 51 by, for example, designating two or more control points around the region of a suspect lesion in the examination image. A frame line with smooth curves depicted by alternate long and short dashed lines, which pass through the control points, and a region inside the frame line are designated as the region R. In this example, the region R has an indefinite shape. The frame line and the control points may be changed or corrected with the cursor 51. Note that a rectangular frame line, a circular frame line, an oval frame line, or the like may be displayed in the image display area 48. The region R may be designated by enlarging or reducing the size of the frame line with the cursor 51.

The automatic region extraction button 53 is an operation button for allowing the program controller 37 to automatically extract the region R. The viewer program 35 has an automatic extraction function to automatically extract the region R. Immediately after the automatic region extraction button 53 is selected with the cursor 51, the program controller 37 executes the automatic extraction of the region R through the automatic extraction function and the frame line indicating the region R is displayed in the image display area 48. After the automatic region extraction button 53 is selected and the region R is automatically extracted, the manual region extraction button 52 may be selected to manually change or correct the automatically-extracted region R.

A method described in “A Machine learning approach for interactive lesion segmentation (Li Y., Hara S., Ito W., et al. Proc. SPIE 2007; 6512: 651246-8)” may be used as the automatic extraction function. In this method, a point within a region of a suspect lesion or two points at the ends of the region of the suspect lesion are designated to extract the region R. Note that any well-known method (e.g. a region extension method or Snakes method) may be used instead.

The clear button 54 is an operation button for canceling (or deselecting) the region R extracted. Immediately after the clear button 54 is selected with the cursor 51, the frame line displayed in the image display area 48 disappears and thereby the image display area 48 returns to the state before the extraction of the region R.

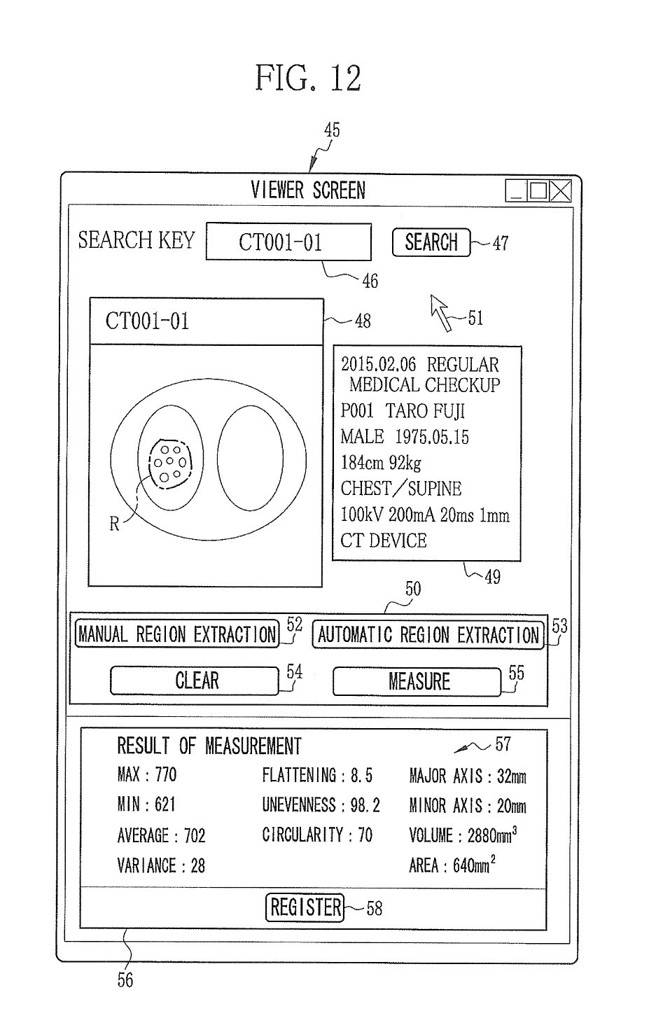

Immediately after the measurement button 55 is selected with the cursor 51 after the extraction of the region R, the program controller 37 calculates the measurement values of the region R. A measurement result display area 56 (see FIG. 12) appears in the viewer screen 45.

In FIG. 12, the measurement result display area 56 displays text information 57 and a registration button 58. The text information 57 shows various measurement values calculated by the program controller 37. The registration button 58 is used for inputting the measurement registration command for the registration of the measurement values (or the calculated values). Immediately after the registration button 58 is selected with the cursor 51, the request issuer 38 issues the measurement registration request for the registration of the measurement values.

In FIG. 13, the delivery request screen 60 is provided with an input box 61 and a transmission button 62, which are used for inputting the information delivery command for the delivery of the diagnostic support information. Immediately after the transmission button 62 is selected with the cursor 51 after the patient ID is inputted to the input box 61, the request issuer 38 issues the information delivery request for the delivery of the diagnostic support information of the corresponding patient.

Note that FIG. 10 to FIG. 13 illustrate the client terminal apparatus 13 and the screens 45 and 60 by way of example. Depending on the specification of the viewer program 35, a function to manually designate the region R or the automatic extraction function of the region R may be omitted or the measurement registration request may be issued automatically without the use of the registration button 58 after the measurement (calculation).

An algorithm for extracting the region R by the automatic extraction function and an algorithm for calculating the measurement value vary according to the specification of the viewer program 35. For this reason, the measurement values (the calculated values) obtained by two or more measurements with respect to the same lesion in the same examination image may vary. The measurement values calculated with respect to one lesion that is manually designated and extracted from the image may also vary in the case where the measurement values are calculated using two or more different viewer programs 35. Even if the measurement values are calculated with respect to the same region R, the measurement values (the calculated values) vary with different algorithms of the viewer programs 35 for calculating the measurement values.

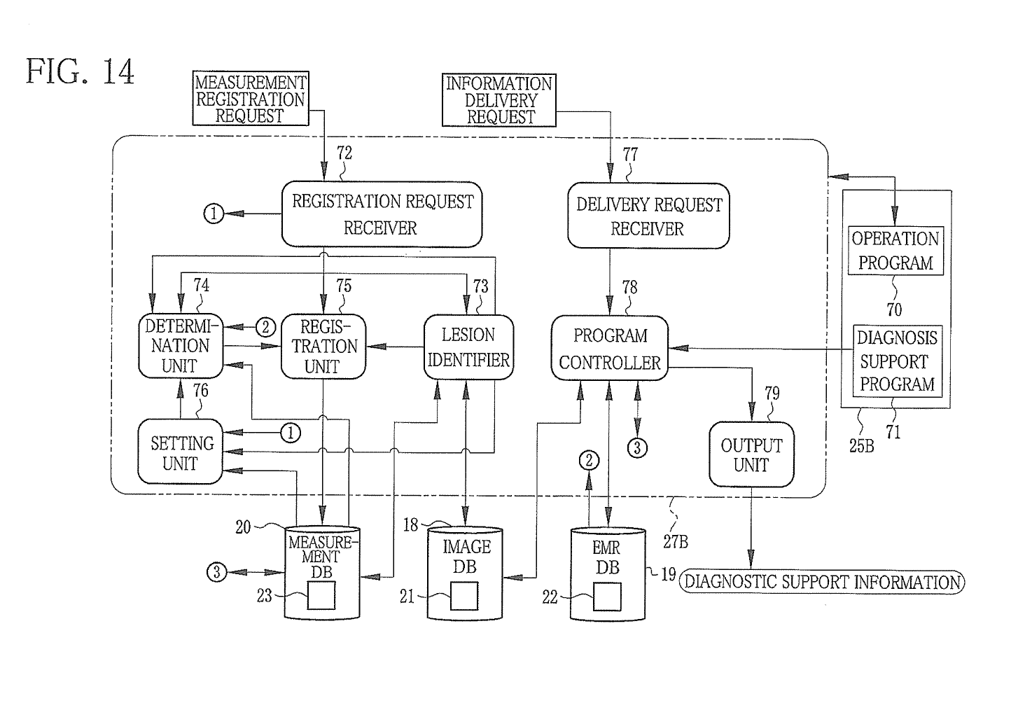

In FIG. 14, a storage device 25B of the diagnosis support server apparatus 14 stores an operation program 70 and a diagnosis support program 71. The operation program 70 is an application program that allows the computer constituting the diagnosis support server apparatus 14 to function as the measurement value management apparatus. The diagnosis support program 71 is an application program to generate the diagnostic support information.

Upon the start of the operation program 70, a CPU 27B of the diagnosis support server apparatus 14 works together with the memory 26, and thereby functions as a registration request receiver 72, a lesion identifier 73, a determination unit 74, a registration unit 75, a setting unit 76, a delivery request receiver 77, a program controller 78, and an output unit 79.

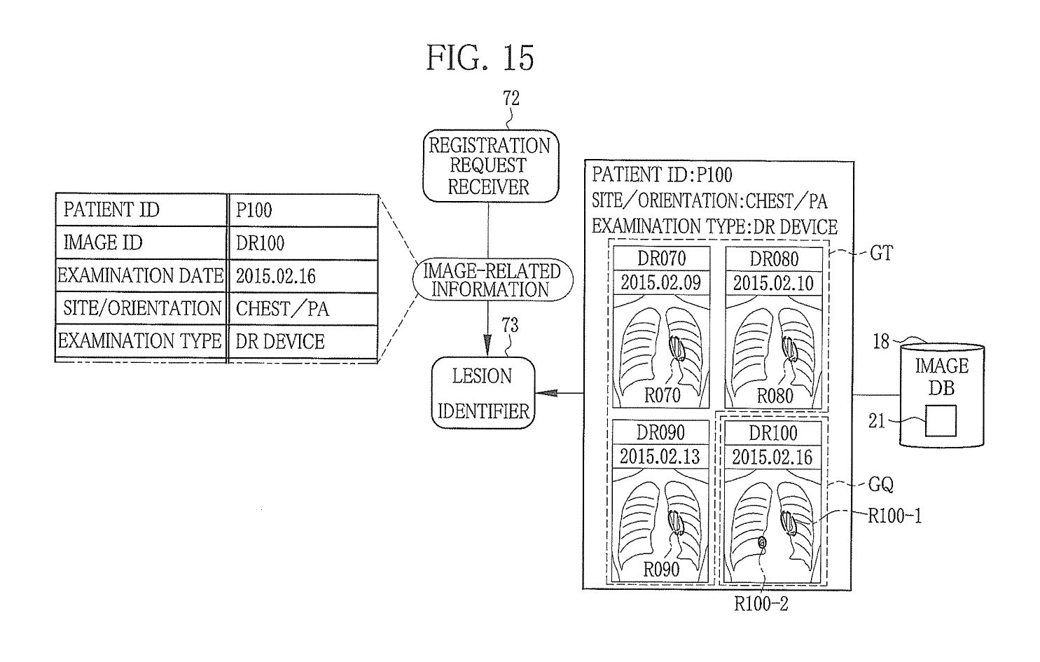

The registration request receiver 72 receives the measurement registration request, which is sent from the client terminal apparatus 13 and received through the communication unit 28. The registration request receiver 72 outputs the image-related information and the measurement information of the received measurement registration request to the lesion identifier 73. The registration request receiver 72 outputs the measurement information to the determination unit 74. The registration request receiver 72 outputs the image ID of the image-related information, the measurer-related information, and the measurement information to the registration unit 75. The registration request receiver 72 outputs the image ID of the image-related information to the setting unit 76. Note that, hereinafter, the examination image associated with the image-related information of the received measurement registration request is referred to as the query image GQ (see FIG. 15).

In the image list 21, the lesion identifier 73 searches for an examination image (hereinafter referred to as the target image GT, see FIG. 15) of the same patient, the same body site, the same orientation, and the same examination type as in the query image GQ. In the case where the target image GT is retrieved, the lesion identifier 73 determines whether the lesion in the query image GQ is the same as that in the target image GT.

Upon determining that the lesion in the query image GQ is the same as that in the target image GT, the lesion identifier 73 provides the lesion in the query image GQ with the same lesion ID as the lesion in the target image GT. In the case where the lesion identifier 73 could not retrieve the target image GT or determined that the lesion in the query image GQ is different from the lesion in the target image GT, the lesion identifier 73 provides the lesion in the query image GQ with a new lesion ID. The lesion identifier 73 outputs the lesion ID to the determination unit 74, the registration unit 75, and the setting unit 76.

The determination unit 74 determines the presence or absence of the reliability of the measurement values of the major axis length and the minor axis length of the measurement information outputted from the registration request receiver 72, and outputs the determination results to the registration unit 75.

In the case where the image ID of the query image GQ in the measurement value list 23 has already been associated with the lesion ID outputted from the lesion identifier 73, the registration unit 75 registers the measurer-related information and the measurement information, which are outputted from the registration request receiver 72, and the determination result, which is outputted from the determination unit 74, in association with the item “lesion ID” in the measurement value list 23.

In the case where the image ID, which is outputted from the registration request receiver 72, of the query image GQ has not been registered in the measurement value list 23, the registration unit 75 sets up the item “image ID”. The registration unit 75 registers the image ID, the measurer-related information, and the measurement information, which are outputted from the registration request receiver 72, and the determination result, which is outputted from the determination unit 74, in association with each other in the measurement value list 23. In the case where the image ID of the query image GQ in the measurement value list 23 has not been associated with the lesion ID, which is outputted from the lesion identifier 73, the registration unit 75 sets up the item “lesion ID”. The registration unit 75 registers the lesion ID, the measurer-related information, the measurement information, and the determination result in association with each other in the measurement value list 23.

The setting unit 76 selects a method for determining the presence or absence of the reliability of the measurement values of the major axis length and/or the minor axis length in accordance with the number of the measurement values with which the image ID, which is outputted from the registration request receiver 72, of the query image GQ and the lesion ID from the lesion identifier 73 are associated.

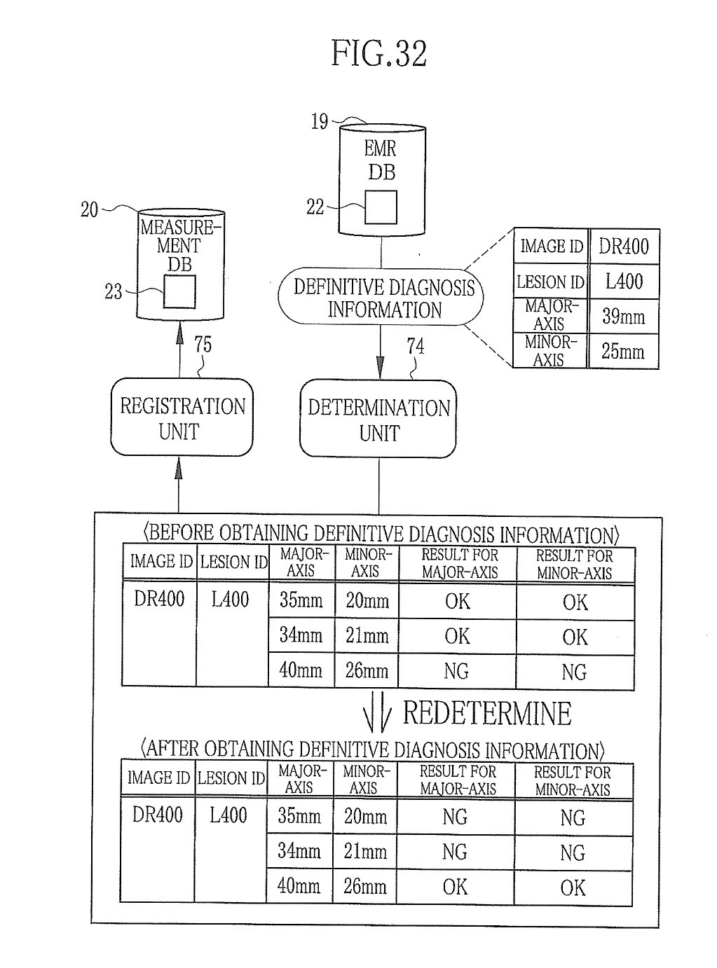

In the case where the number of the measurement value of the major or minor axis length with which the image ID, which is outputted from the registration request receiver 72, of the query image GQ and the lesion ID, which is outputted from the lesion identifier 73, are associated is 0 or 1, in other words, in the case where each of the extraction of the region R of the lesion with the lesion ID and the measurement (or calculation) of the measurement value has not been performed or has been performed only once, the setting unit 76 performs a comparison with definitive diagnosis information (see FIG. 32), which will be described below, to determine the presence or absence of reliability.

After the diagnostic imaging is performed by the clinician and/or the radiologist, a pathologist performs pathologic diagnosis of the lesion in the examination image. In the pathologic diagnosis, the major axis length and the minor axis length of the lesion (or the region R) are measured by actual measurement of the lesion removed by the surgery, for example. In medical facilities, it is a common practice to determine the result of the pathologic diagnosis as the final diagnosis (definitive diagnosis). The measured values (the measurement values) obtained through the pathologic diagnosis, a pathologic sample image, and findings recorded by the pathologist are registered as the definitive diagnosis information of the lesion in the EMR list 22.

In the case where the number of the measurement value of the major or minor axis length with which the image ID, which is outputted from the registration request receiver 72, of the query image GQ and the lesion ID, which is outputted from the lesion identifier 73, are associated is 0 or 1, the determination unit 74 acquires the definitive diagnosis information from the EMR list 22. The determination unit 74 compares the measurement value with respect to the lesion in the query image GQ with the definitive diagnosis information to determine the presence or absence of the reliability.

On the other hand, in the case where the number of the measurement values of the major or minor axis length with which the image ID, which is outputted from the registration request receiver 72, of the query image GQ and the lesion ID, which is outputted from the lesion identifier 73, are associated is 2 or more, in other words, in the case where the region R of the lesion with the lesion ID is extracted two or more times and the measurement values are measured (or calculated) two or more times, the setting unit 76 calculates standard deviation of the two or more measurement values of the major or minor axis length and sets the calculated standard deviation as a threshold value. In an example in FIG. 8, three measurement values of the major axis length and three measurement values of the minor axis length are registered for the lesion ID “L001”. Two measurement values of the major axis length and two measurement values of the minor axis length are registered for the lesion ID “L002”. Hence the lesion IDs “L001” and “L002” are applicable to this case. The setting unit 76 outputs the threshold value to the determination unit 74.

The delivery request receiver 77 receives the information delivery request, which is sent from the client terminal apparatus 13, through the communication unit 28. The delivery request receiver 77 outputs the patient ID, which is contained in the information delivery request, to the program controller 78.

The program controller 78 controls the operation of the diagnosis support program 71. In other words, the diagnosis support program 71 is executed under the control of the program controller 78. The program controller 78 generates the diagnostic support information and outputs the generated diagnostic support information to the output unit 79.

Based on the patient ID from the delivery request receiver 77, the program controller 78 retrieves the data to be outputted as the diagnostic support information, from the lists 21 to 23. To be more specific, the program controller 78 retrieves the examination image with which the patient ID from the delivery request receiver 77 is associated, from the image list 21. From the measurement value list 23, the program controller 78 retrieves the measurement information with which the image ID of the retrieved examination image is associated, the measurer-related information, and the determination result. From the EMR list 22, the program controller 78 retrieves the EMR with which the patient ID from the delivery request receiver 77 is associated.

The output unit 79 outputs the diagnostic support information, which is outputted from the program controller 78, through the communication unit 28 to the client terminal apparatus 13, which sent the information delivery request.

The CPU 27B of the diagnosis support server apparatus 14 further comprises a receiving unit, a registration unit, a retrieval unit, and the like (all not shown). The receiving unit receives the image registration request, the image delivery request, the EMR registration request, and the EMR delivery request. The registration unit registers the examination image to the image list 21 based on the image registration request and registers the EMR to the EMR list 22 based on the EMR registration request. The retrieval unit retrieves the examination image from the image list 21 based on the image delivery request and retrieves the EMR from the EMR list 22 based on the EMR delivery request. The output unit 79 outputs the examination image and the EMR, which are retrieved by the retrieval unit, through the communication unit 28 to the client terminal apparatus 13, which sent the image delivery request and the EMR delivery request.

FIGS. 15 to 18 illustrate a specific example of a process (lesion identification process) for identifying a lesion, performed by the lesion identifier 73. In the example illustrated in FIG. 15, the image-related information, which is outputted from the registration request receiver 72, specifies that the patient ID is “P100”; the image ID of the examination image is “DR100”; the date of the examination is “2015.02.16”; the body site examined and the orientation are “chest/PA”; and the examination type is “plain radiography device (abbreviated as DR (digital radiography) device in the drawing)”. The lesion identifier 73 retrieves the examination image (the query image GQ) with the image ID “DR100” and three examination images (the target images GT) with the image IDs “DR070”, “DR080”, and “DR090” from the image list 21, for example. The target images GT have the patient ID “P100”, the body site examined and the orientation “chest/PA”, and the examination type “plain radiography device (abbreviated as DR (digital radiography) device in the drawing)”. The query image GQ and the target images GT are the examination images of the same body site of the same patient captured by the same modality 16 on different examination dates.

Next, the lesion identifier 73 performs image registration (image alignment) of the query image GQ and the target images GT to eliminate positional errors. For example, an anatomical site is extracted from each image by image analysis and the image registration is performed with reference to the extracted anatomical site.

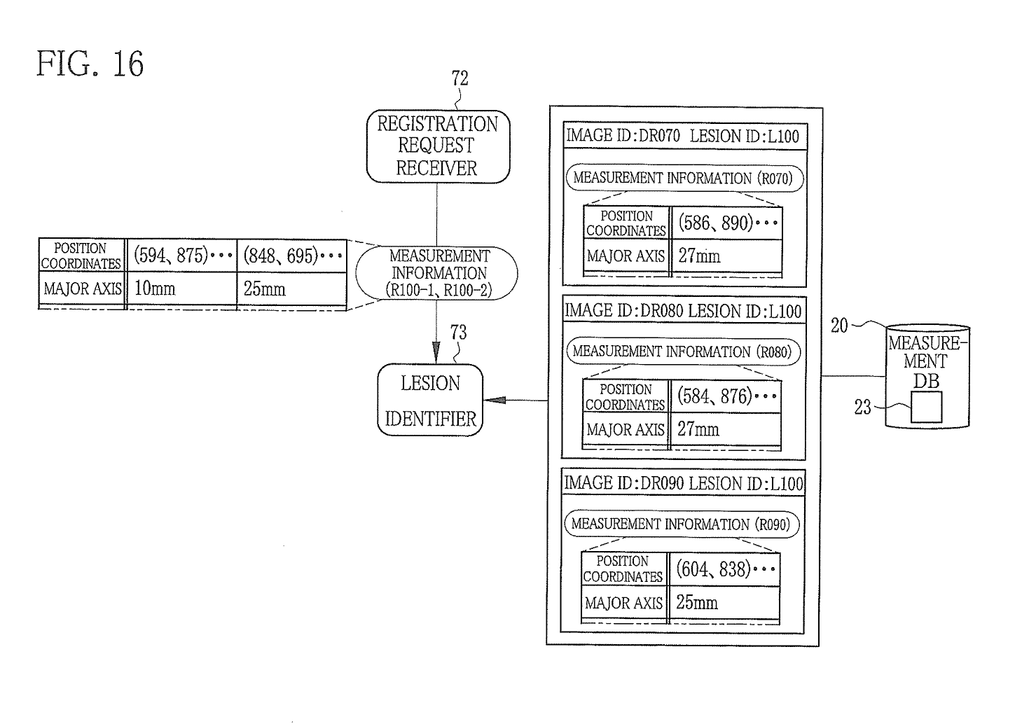

Then, as illustrated in FIG. 16, the lesion identifier 73 retrieves the measurement information of the target images GT with the image IDs “DR070”, “DR080”, and “DR090” from the measurement value list 23. In the example shown in FIG. 16, the examination images with the image IDs “DR070”, “DR080”, and “DR090” are previously identified as the same image by the lesion identifier 73. Hence the registered measurement information associated with the respective image IDs “DR070”, “DR080”, and “DR090” have the same lesion ID.

The measurement information of the target images GT with the image IDs “DR070”, “DR080”, and “DR090” correspond to the regions R070, R080, and R090, respectively, shown in FIG. 15. The measurement information of the query image GQ with the image ID “DR100” corresponds to the two regions R100-1 and R100-2 shown in FIG. 15. The lesion in the region R100-2 had not existed at the time of capturing the examination image of the image ID “DR090” and appeared at the time of capturing the examination image of the image ID “DR100”.

The lesion identifier 73 determines whether the regions R100-1 and R100-2 (of the lesions) represented by the measurement information of the query image GQ are the same as the regions R070, R080, and R090 (of the lesions) represented by the measurement information of the target images GT based on the measurement information of the query image GQ with the image ID “DR100” and the measurement information of the target images GT with the image IDs “DR070”, “DR080”, and “DR090”. The measurement information of each image is retrieved from the measurement value list 23.

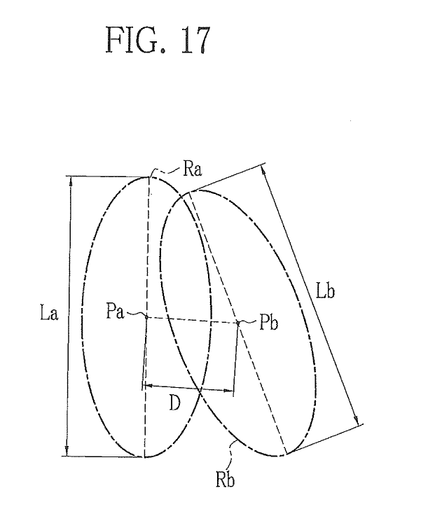

For example, a method illustrated in FIG. 17 is used to determine whether the regions are the same. First, the lesion identifier 73 calculates centers or barycentric positions Pa and Pb of the regions Ra and Rb based on the position coordinates of the measurement information of the regions Ra and Rb, respectively. The lesion identifier 73 calculates a distance D between the positions Pa and Pb.

The lesion identifier 73 compares the distance D with ½ (max (La, Lb)/2), that is, a half (½) of one of a major axis La of the region Ra and a major axis Lb of the region Rb greater than the other. In the case where the distance D is less than the half (½) of one of the major axis La and the major axis Lb greater than the other (D<max (La, Lb)/2), the lesion identifier 73 determines that the regions Ra and Rb are the same region. In the case where the distance D is greater than or equal to the half (½) of one of the major axis La and the major axis Lb greater than the other (D≧max (La, Lb)/2), the lesion identifier 73 determines that the region Ra is different from the region Rb. In other words, one of the regions Ra and Rb corresponds to the region R100-1 or R100-2 of the lesions represented by the measurement information of the query image GQ. The other of the regions Ra and Rb corresponds to the regions R070, R080, and R090 of the lesion represented by the measurement information of the target images GT. Note that the regions Ra and Rb may be determined to be the same in the case where the distance D falls within a predetermined range (for example, within a range of 1 cm or less).

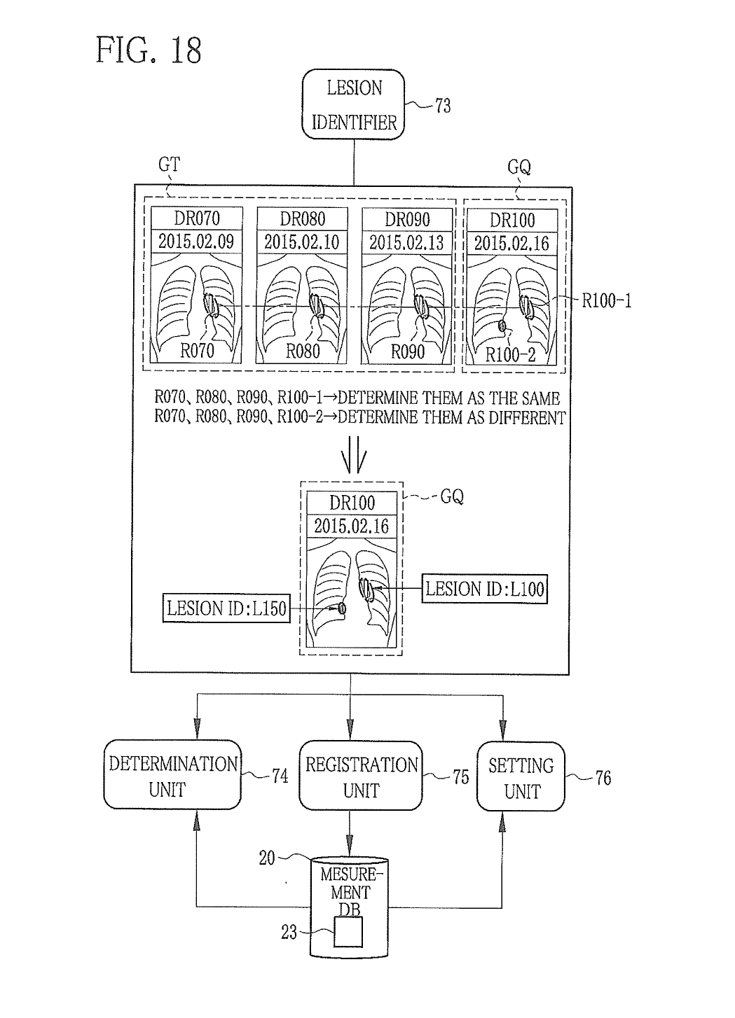

In FIG. 18, upon determining that the region R100-1, which is represented by the measurement information of the query image GQ, and all of the regions R070, R080, and R090, which are represented by the measurement information of the target images GT, are the same, the lesion identifier 73 provides the lesion represented by the measurement information of the region R100-1 with the same lesion ID “L100” as the regions R070, R080, and R090.

In the case where the lesion identifier 73 determines that the region R100-2 corresponding to the lesion represented by the measurement information of the query image GQ is different from one of the regions R070, R080, and R090 corresponding to the lesion represented by the measurement information of the target images GT, the lesion identifier 73 provides the lesion corresponding to the measurement information of the region R100-2 with a new lesion ID “L150”.

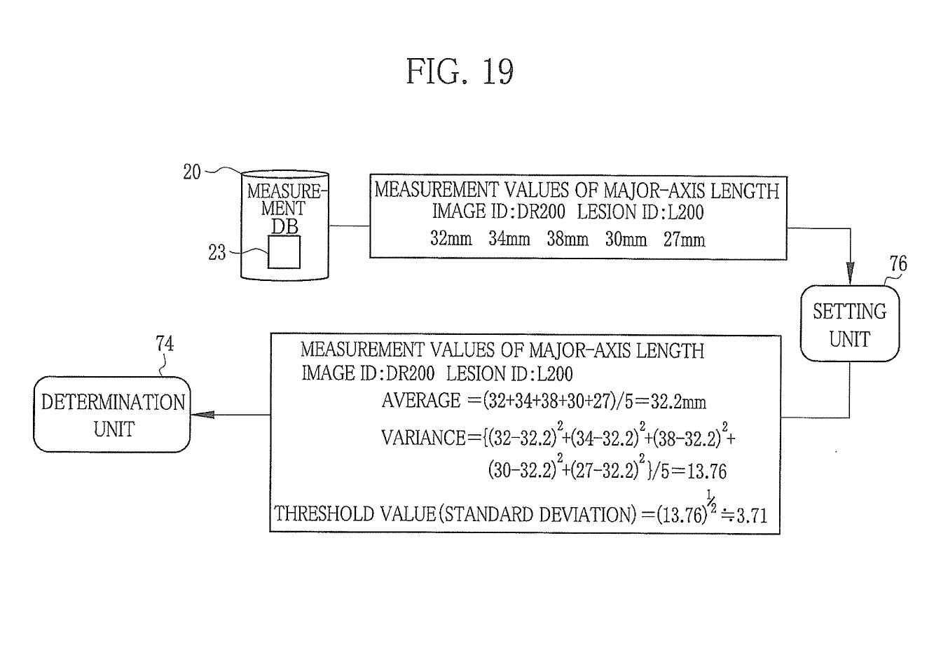

FIG. 19 to FIG. 21 illustrate examples of a threshold setting process for setting a threshold value and a reliability determination process for determining the presence or absence of the reliability of the measurement value (or the calculated value). The setting unit 76 performs the threshold setting process. The determination unit 74 performs the reliability determination process. In FIG. 19, for example, the image ID of the query image GQ is “DR200”. The lesion ID determined by the lesion identifier 73 is “L200”. Each of the extraction of the region R and the measurement of the measurement value (in this example, the major axis length) is performed five times with respect to the lesion with the image ID “DR200” and the lesion ID “L200”. Five measurement values of the major axis length, 32 mm, 34 mm, 38 mm, 30 mm, and 27 mm are registered in the measurement information corresponding to the image ID “DR200” and the lesion ID “L200” in the measurement value list 23. In this case, the setting unit 76 sets the threshold value based on the standard deviation of the five measurement values of the major axis length.

To be more specific, the average value of the five major axis lengths=(32+34+38+30+27)/5=32.2, and variance={(32−32.2)̂2+(34−32.2)̂2+(38−32.2)̂2+(30−32.2)̂2+(27−32.2)̂2}/5=13.76. The standard deviation=(13.76)̂1/2≈3.71. Hence the threshold value is set to 3.71 in this example.

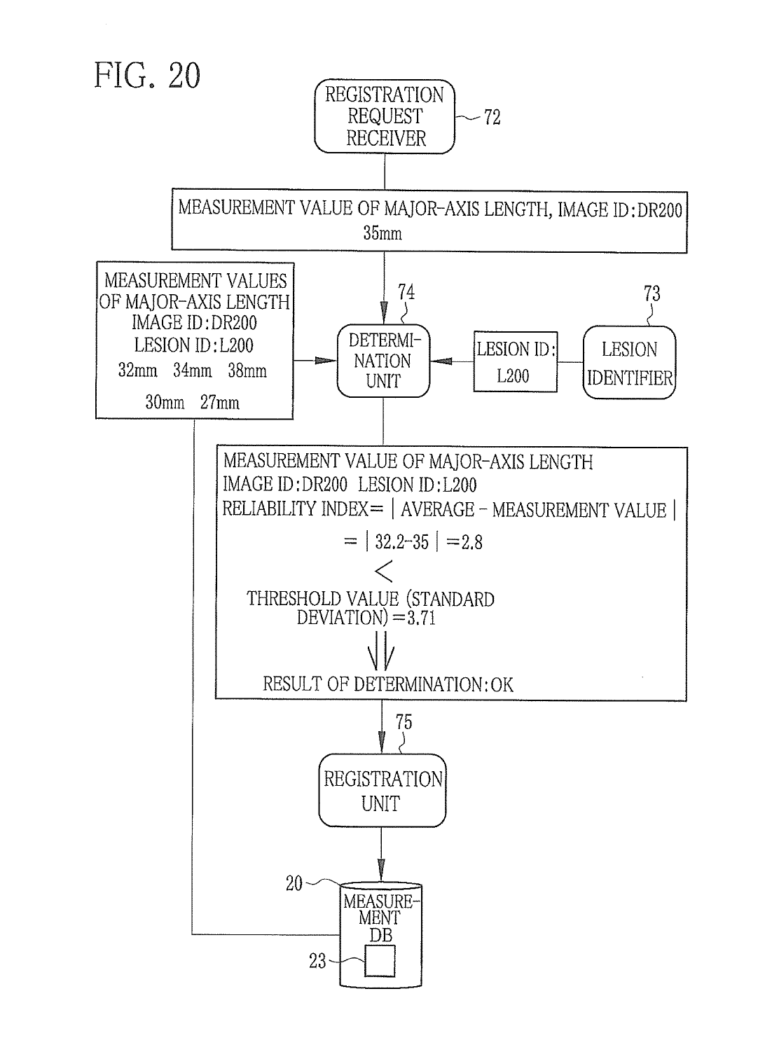

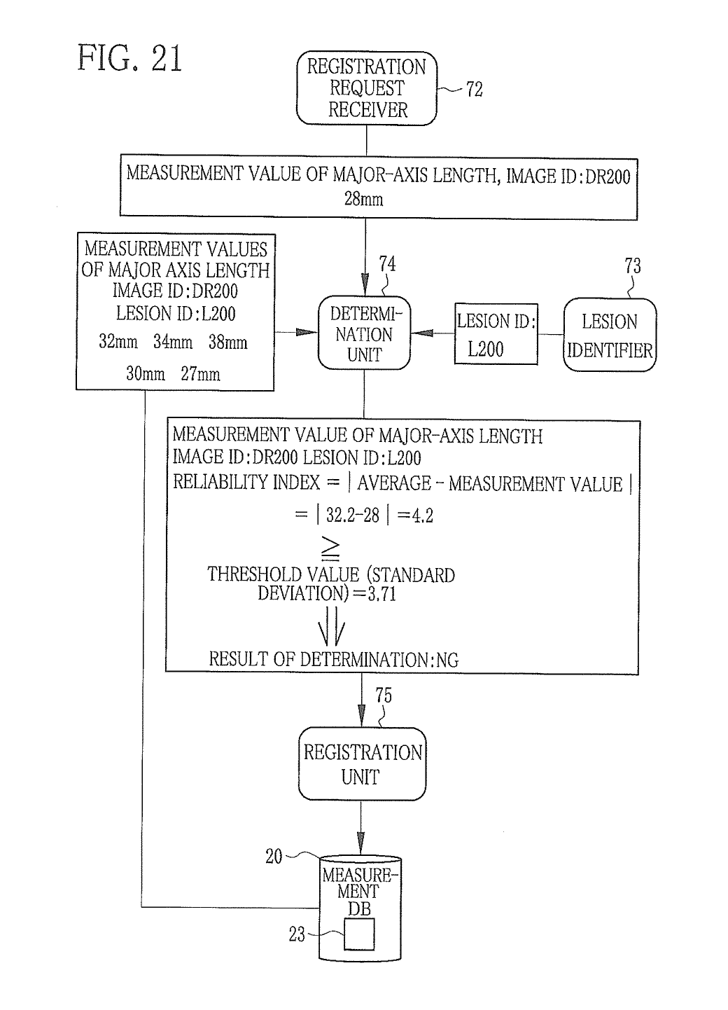

In FIGS. 20 and 21, from the measurement value list 23, the determination unit 74 reads the measurement values of the major axis length, 32 mm, 34 mm, 38 mm, 30 mm, and 27 mm of the lesion with which the image ID “DR200”, which is outputted from the registration request receiver 72, of the query image GQ and the lesion ID “L200” outputted from the lesion identifier 73 are associated. The determination unit 74 calculates the average value of the measurement values. In other words, in this example, the determination unit 74 calculates the average value of the measurement values of the major axis length read from the measurement value list 23. The determination unit 74 calculates an absolute value (|the average value−the measurement value|) of a difference between the calculated average value and the measurement value (that is, the major axis length in this example), which is outputted from the registration request receiver 72, of the query image GQ. The calculated absolute value (|the average value—the measurement value|) is used as a reliability index, which quantitatively represents the reliability of the measurement value.

The determination unit 74 compares the magnitude of the reliability index with the magnitude of threshold value outputted from the setting unit 76. The determination unit 74 determines that the measurement value is reliable (in other words, the determination result is “OK (reliable)”) in the case where the reliability index<the threshold value and determines that the measurement value is unreliable (in other words, the determination result is “NG (unreliable)” in the case where the reliability index≧the threshold value.

FIG. 20 shows an example in which the major axis length “35 mm” of the query image GQ is registered as the measurement value. FIG. 21 shows an example in which the major axis length “28 mm” of the query image GQ is registered as the measurement value. In FIG. 20, |the average value—the measurement value|=|32.2−35|=2.8<3.71. Hence the determination result is “OK (reliable)”. In other words, the major axis length “35 mm” is reliable. In FIG. 21, |the average value—the measurement value|=|32.2−28|=4.2≧3.71. Hence the determination result is “NG (unreliable)”. In other words, the major axis length “28 mm” is unreliable.

Note that, in FIGS. 19 to 21, only the measurement value of the major axis length was described by way of example. In a like manner, the setting unit 76 sets a threshold value for the measurement value of the minor axis length and the determination unit 74 determines the presence or absence of the reliability of the measurement value of the minor axis length.

In the examples shown in FIGS. 19 to 21, there are two or more measurement values of the major or minor axis length with which the image ID, which is outputted from the registration request receiver 72, of the query image GQ and the lesion ID, which is outputted from the lesion identifier 73, are associated and the standard deviation is set as the threshold value. There may be cases where the number of the measurement values of the major or minor axis length with which the image ID and the lesion ID are associated is 0 or 1. In this case, the determination unit 74 calculates a difference between the measurement value with respect to the lesion in the query image GQ and the measurement value in the definitive diagnosis information and uses the calculated difference as the reliability index. The determination unit 74 determines that the measurement value with respect to the lesion in the query image GQ is reliable in the case where the difference is less than or equal to a predetermined threshold value, and determines that the measurement value with respect to the lesion in the query image GQ is unreliable in the case where the difference is greater than the threshold value.

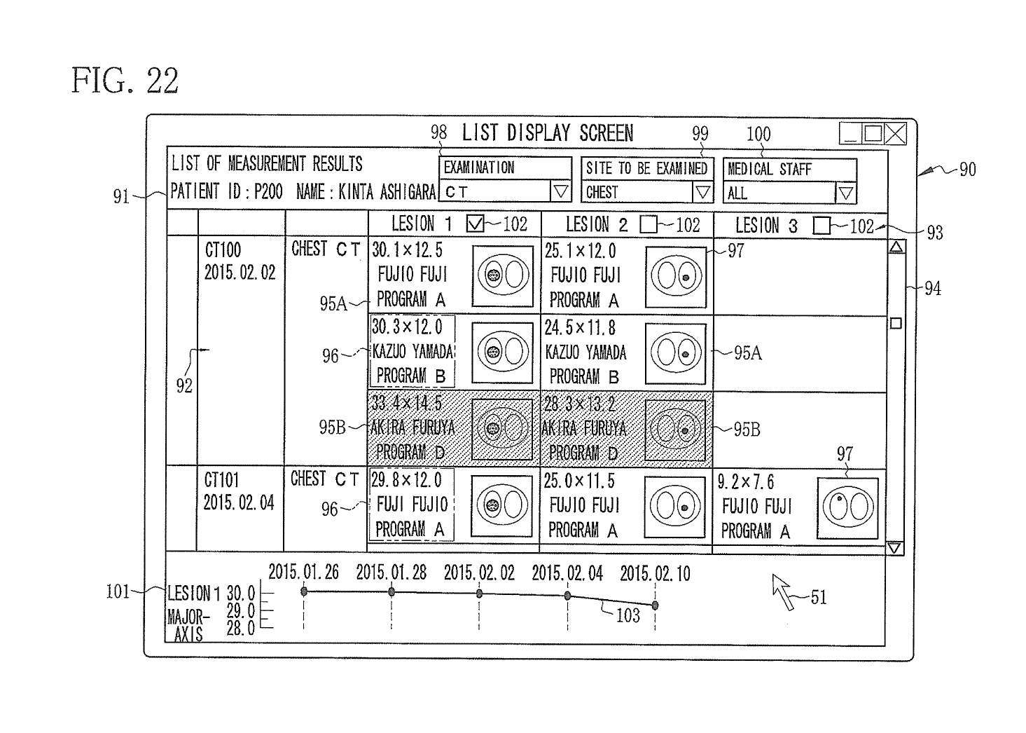

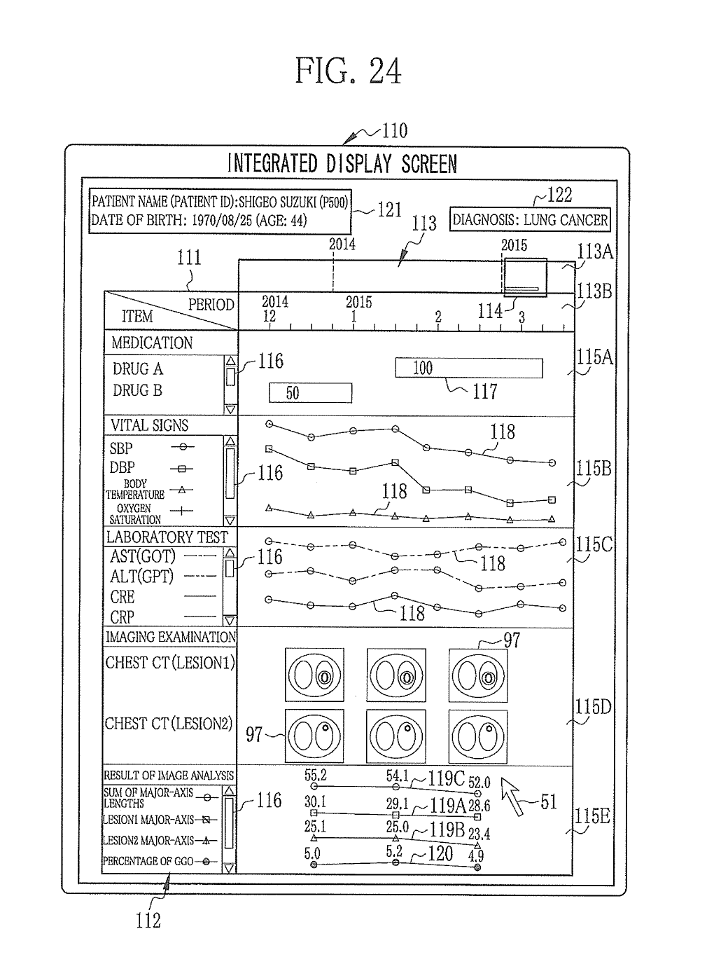

Based on the diagnostic support information from the diagnosis support server apparatus 14, more specifically, based on the measurement information, the measurer-related information, the determination result, or the medical data retrieved based on the patient ID, which is contained in the information delivery request, the program controller 37 of the client terminal apparatus 13 generates a list display screen 90 (see FIG. 22) and an integrated display screen 110 (see FIG. 24) and outputs the list display screen 90 and the integrated display screen 110 to the GUI controller 36. The GUI controller 36 displays the screens 90 and 110 independently or at the same time or in a selectable manner on the display 29A.

In FIG. 22, the list display screen 90 comprises a list display area 91. Along a vertical axis of the list display area 91, a display section 92 is disposed. The display section 92 displays the image ID, the date of the examination, the body site to be examined, and the examination type. Along a horizontal axis of the list display area 91, a display section 93 for displaying a lesion is disposed. A scroll bar 94 is disposed to the side of the list display area 91. A portion not fit into or temporarily not displayed in the list display area 91 is viewed through a vertical scroll operation of the scroll bar 94.

In the case where the number of the lesion in the examination image displayed in the display section 92 is one, one item corresponding to the lesion is displayed in the display section 93. In the case where the number of the lesions in the examination image displayed in the display section 92 is two or more, the items corresponding to the respective lesions are displayed in the display section 93. In an example shown in FIG. 22, there are three lesions in the examination image displayed in the display section 92, so that three items (“lesion 1”, “lesion 2”, and “lesion 3”) are displayed in the display section 93.

A cell 95 is disposed at an intersection point of the display sections 92 and 93. The cell 95 displays text information 96 and a thumbnail image 97. The text information 96 includes the measurement values (the major axis length and the minor axis length, for example, “30.1×12.5”) of the measurement information, the name (e.g. Fujio FUJI) of the medical staff identified by the staff ID contained in the measurer-related information, and the name (e.g. the program A) of the viewer program 35 identified by the program ID contained in the measurer-related information. The thumbnail image 97 corresponds to the examination image.

In the case where the region R is extracted two or more times and the measurement values are measured two or more times with respect to the same lesion in the same examination image, the number of the cells 95 corresponding to the number of the extractions (or the number of the measurements) are disposed for one image ID with one examination date, one body site to be examined, and one examination type in the display section 92 or for corresponding item (e.g. “lesion 1”) in the display section 93. In the example shown in FIG. 22, the region R is extracted three times and the measurement values are measured three times with respect to each of the “lesion 1” and the “lesion 2” in the examination image with the image ID “CT100”, the date of examination “2015.02.02”, the body site to be examined (“chest”), and the examination type “CT”. The three cells 95 are disposed for each of the items “lesion 1” and “lesion 2” in the display section 93.

The cell 95 with the determination result “OK (reliable)” is displayed differently from the cell 95 with the determination result “NG (unreliable)”. In FIG. 22, for example, cells 95A with the determination result “OK” are displayed in a chromatic color (e.g. yellow or the like) and cells 95B with the determination result “NG” are displayed in an achromatic color (e.g. gray or the like), which is represented by a hatch pattern.

Note that the cells 95 may be displayed in a different manner to distinguish between the cells 95A with the determination result “OK” and the cells 95B with the determination result “NG”. For example, the text information 96 of the cells 95A may be displayed in bold type and the text information 96 of the cells 95B may be displayed in thin type. The cells 95B may be flashed on and off. The cells 95B may be displayed translucently. There are various ways to make the cells 95A and 95B distinguishable from each other. The cell 95 may display text information of the determination result or a mathematical expression used as a basis of the determination. The mathematical expression represents the magnitude relationship between the reliability index and the threshold value. Alternatively, the cell 95 may not be displayed in the case where the determination result is “NG (unreliable)”.

An upper portion of the list display area 91 displays the text information (the patient ID, which is included in the information delivery request, and the name of the patient) and pulldown menus 98, 99, and 100. The pulldown menu 98 is used to select an examination type (that is, a type of the modality 16). The pulldown menu 99 is used for selecting a body site to be examined. The pulldown menu 100 is used for selecting a medical staff. The pulldown menus 98 to 100 are provided to narrow down the cells 95, which are displayed in the list display area 91, by the examination type, the body site to be examined, and the medical staff. In the example shown in FIG. 22, “CT” is selected from the pulldown menu 98, “chest” is selected from the pulldown menu 99, and “all” is selected from the pulldown menu 100. Thereby the cells 95 related to the “chest CT” are selectively displayed in the list display area 91. Note that an input box may be provided in addition to the pulldown menus 98 to 100. A period (e.g. last three months, a year ago, or the like) is inputted to the input box.

A graph display area 101 is displayed in a lower portion of the list display area 91. A line graph 103 is displayed in the graph display area 101. The line graph 103 shows chronological changes in the measurement values of the major axis length of the lesion (“lesion 1” in the example shown in FIG. 22) selected through a check box 102. The check box 102 is provided to the side of each name (e.g. lesion 1, lesion 2, or lesion 3) of the item “lesion” in the display section 93. The line graph 103 with a vertical axis representing the major axis length and a horizontal axis representing the date of examination is drawn by plotting the measurement values of the major axis length measured on the respective examination dates and connecting them by a line.

Only the measurement values that are determined to be reliable by the determination unit 74 are used for drawing the line graph 103 and the measurement values that are determined to be unreliable are eliminated therefrom. For example, there are three measurement values of the major axis length of the “lesion 1” measured on the examination date “2015.02.02”. They are the measurement value “30.1” measured by the medical staff “Fujio FUJI”, the measurement value “30.3” measured by the medical staff “Kazuo YAMADA”, and the measurement value “33.4” measured by the medical staff “Akira FURUYA”. However, the measurement value “33.4” measured by the medical staff “Akira FURUYA” is determined to be unreliable. Hence, the measurement value “33.4” is excluded and the average value “30.2” of the two measurement values “30.1” and “30.3” is used as the measurement value of the examination date “2015.02.02” on the line graph 103.

Note that, of the measurement values that are determined to be reliable by the determination unit 74, the measurement values measured by the same medical staff may be given a high priority to be used for the line graph 103. For example, in FIG. 22, the measurement value “30.1” with respect to the lesion 1 measured on the examination date “2015.02.02” and the measurement value “29.8” with respect to the lesion 1 measured on the examination date “2015.02.04”, both measured by the medical staff “Fujio FUJI”, are given a high priority to be used.

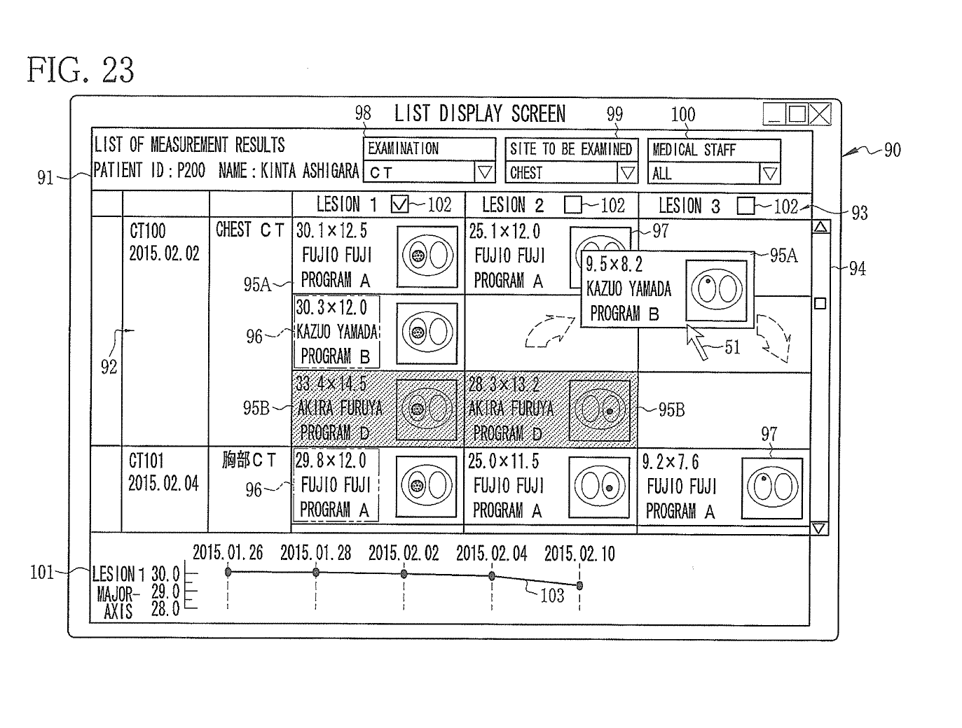

In FIG. 23, the position of the cell 95 is changed by drag and drop operation with the cursor 51. FIG. 23 illustrates that the position of the cell 95 displayed at the intersection point of the image ID “CT100” of the examination date “2015.02.02” and the item “lesion 2” is changed to the position below the item “lesion 3” by the drag and drop operation.

The lesion ID given by the lesion identifier 73 is corrected by the drag and drop operation of the cell 95. More specifically, in response to the drag and drop operation of the cell 95, the request issuer 38 issues a request (a correction request) for correction of the lesion ID. The correction request includes the lesion IDs before and after the drag and drop operation. Upon receiving the correction request, the diagnosis support server apparatus 14 corrects the lesion ID in the measurement value list 23, based on the correction request.

In FIG. 24, the integrated display screen 110 comprises medical data and measurement value display area 111. Along a vertical axis of the medical data and measurement value display area 111, a display section 112 is disposed. The display section 112 displays the names (the items) of broad categories (e.g. “medication”, “vital signs”, “laboratory test”, “imaging examination”, and “results of image analysis”) of the medical data and items (e.g. drug A, body temperature, creatinine, and the like) in the broad categories. The broad category “results of image analysis” is provided with the items (e.g. the measurement values of major axis length, GGO (Ground Glass Opacity) percentage, and the like) conforming to RECIST (Response Evaluation Criteria in Solid Tumors) guidelines, which are used for evaluating cancer treatments.

Along a horizontal axis of the medical data and measurement value display area 111, a display section 113 is disposed. The display section 113 shows time periods in which the medical data and the measurement values displayed in the medical data and measurement value display area 111 are obtained.

The display section 113 is separated into a first display section 113A and a second display section 113B. A period (first period) represented by the first display section 113A is relatively longer in time scale than a period (second period) represented by the second display section 113B.

A period sign 114 is provided in the first display section 113A. The period sign 114 shows that the second period corresponds to which part of the first period. A width of the period sign 114 corresponds to a width of the second period in the time scale of the first period. In the example shown in FIG. 24, the second period is approximately three and a half months from December 2014 to the middle of March 2015, so that the width of the period sign 114 corresponds to the width of approximately three and a half months in the time scale of the first period.

A display area of the second period is changed by moving the period sign 114 in a lateral direction with the cursor 51 or changing the width of the period sign 114. Note that the second period displayed in the integrated display screen 110 by default may be a predetermined time period before the latest medical data or designated by the medical staff at the time the medical staff inputs the patient ID to the delivery request screen 60.

The medical data and measurement value display area 111 is subdivided into sub-areas 115A, 115B, 115C, 115D, and 115E, which correspond to the respective broad categories. The sub-area 115A corresponds to the broad category “medication”. The sub-area 115B corresponds to the broad category “vital signs”. The sub-area 115C corresponds to the broad category “laboratory test”. The sub-area 115D corresponds to the broad category “imaging examination”. The sub-area 115E corresponds to the broad category “result of image analysis”. The display section 112 of each of the sub-areas 115A to 115C and 115E is provided with a scroll bar 116. The sub-area 115D is not provided with the scroll bar 116. A horizontal scroll operation of the scroll bar 116 displays the items not currently displayed.

The sub-area 115A displays a bar 117. The bar 117 indicates the dose and the date of starting and ending the medication of each of the drugs A and B in the second period. Each of the sub-areas 115B and 115C displays line graphs 118. Each line graph 118 is drawn by plotting the measurement data of the vital sign or the examination data of the laboratory test obtained in the second period and connecting them by a line. The display section 112 of the broad category “laboratory test” displays graph legends of the line graphs 118. The sub-area 115D displays the thumbnail images 97 of the examination images captured in the second period. Note that the sub-area 115C may display a normal range of the examination data.

The sub-area 115E displays a line graph 119 and a line graph 120. The line graph 119 is drawn by plotting the measurement values of the major axis length obtained in the second period and connecting them by a line. The line graph 120 is drawn by plotting the GGO percentages obtained in the second period and connecting them with a line. As illustrated in FIG. 24, in the case where there are two or more lesions (e.g. “lesion 1” and “lesion 2”), line graphs 119A and 119B and a line graph 119C are displayed. The line graph 119A shows the measurement values of the major axis length of the lesion 1. The line graph 119B shows the measurement values of the major axis length of the lesion 2. The line graph 119C shows the sum of the measurement value of the major axis length of the lesion 1 and the measurement value of the major axis length of the lesion 2. The display section 112 of the broad category “result of image analysis” displays graph legends of the line graphs 119 and 120.

The measurement data, the examination data, and the plotted points of the measurement data, which form the line graphs 118 to 120, the bar 117, and the thumbnail images 97 displayed in the sub-areas 115A to 115E are disposed in the positions corresponding to the date(s) of the medication, the date(s) of measurement, the date(s) of examination, or the like, in the medical data and measurement value display area 111.

The line graphs 119A, 119B and 119C in the sub-area 115E are drawn by using only the measurement values that are determined to be reliable by the determination unit 74, in a manner similar to the line graph 103 displayed in the list display screen 90. The measurement values that are determined to be unreliable by the determination unit 74 are eliminated. Each of the line graphs 119A and 119B displayed in the sub-area 115E shows the measurement values of the major axis length of the corresponding lesion. The line graph 119C displayed in the sub-area 115E shows the sums of the measurement values of the major axis lengths of the lesions 1 and 2.

The integrated display screen 110 is provided with the medical data and measurement value display area 111, a patient information display area 121, and a diagnosis display area 122. The patient information display area 121 displays text information describing the patient ID contained in the information delivery request, the name, the date of birth, and the age of the patient. The diagnosis display area 122 displays text information describing the diagnosis (e.g. “lung cancer”).

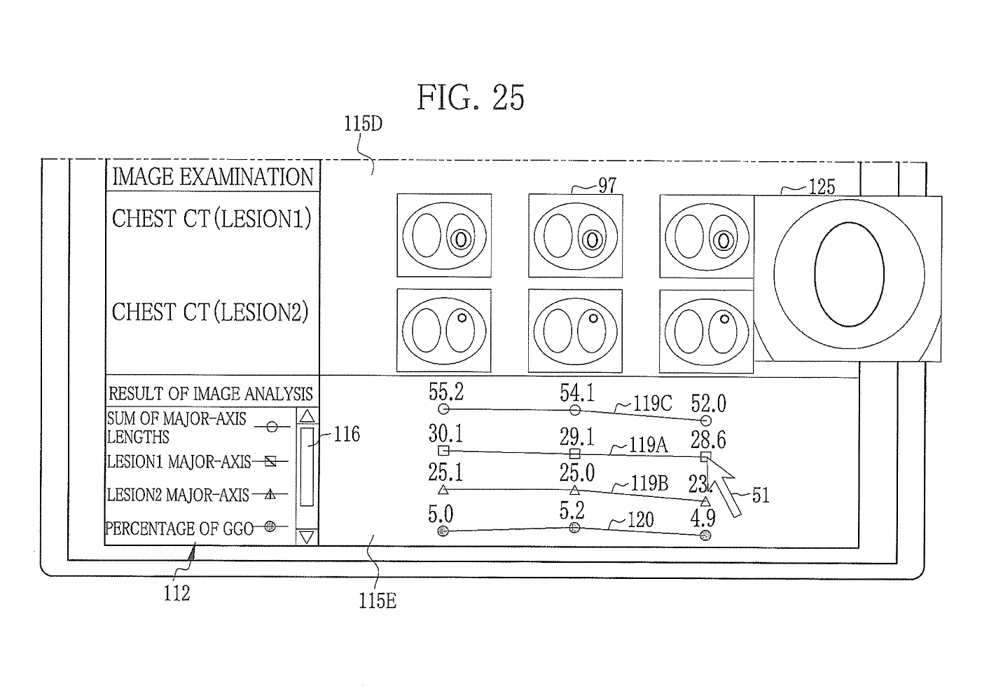

As illustrated in FIG. 25, by placing the cursor 51 on one of plots of the line graphs 119A and 119B, which show the measurement values of the major axis lengths, in the integrated display screen 110, an enlarged image 125 of the lesion is displayed to the side of the thumbnail image 97 of the examination image in which the measurement value of the plot is measured (or calculated).

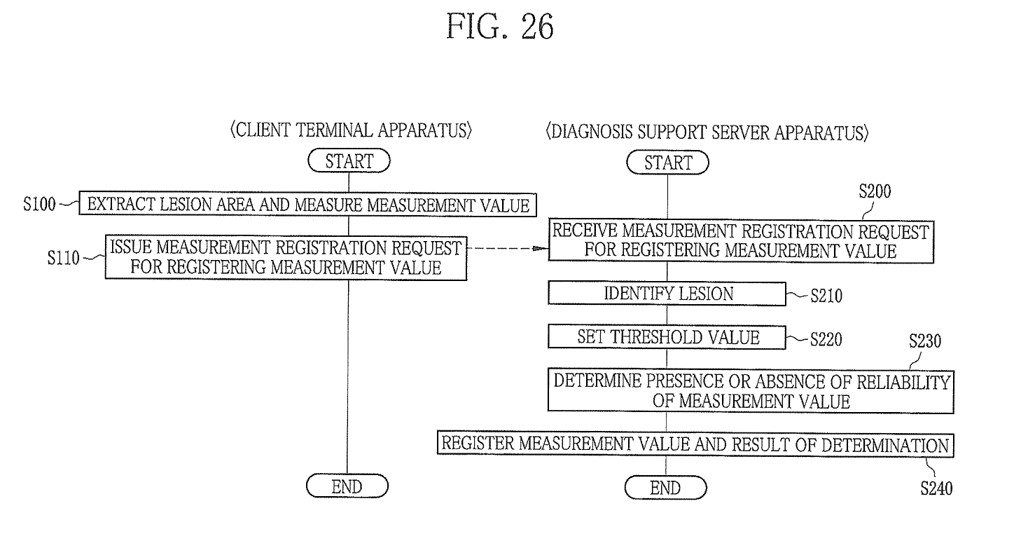

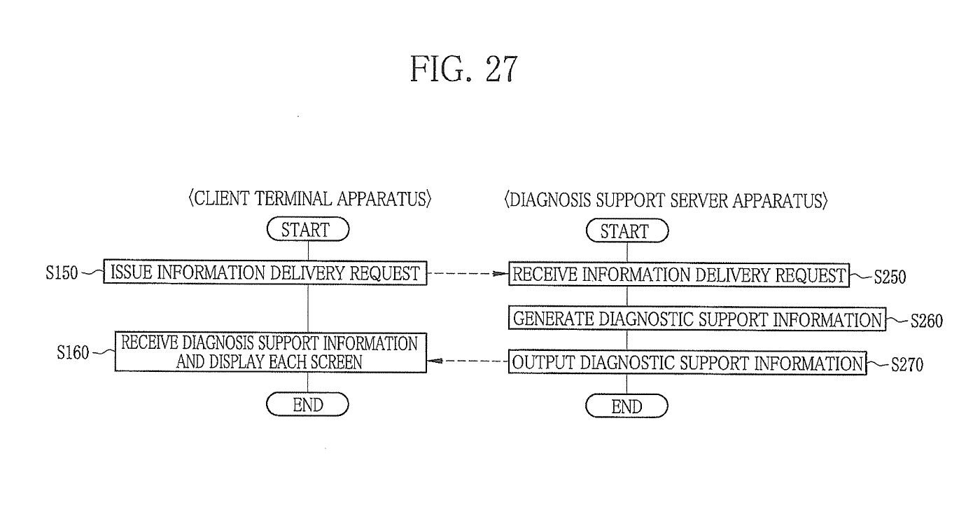

Referring to FIGS. 26 and 27, an operation of the above-described configuration is described. In a step (hereinafter abbreviated as S) 100 in FIG. 26, the medical staff (e.g. the clinician of the clinical department 10, the radiologist of the interpretation department 11, or the like) operates the client terminal apparatus 13 and extracts the region R corresponding to the lesion in the examination image and measures (or calculates) a measurement value through the viewer screen 45 shown in FIG. 11. Thereby the program controller 37 calculates the measurement value with respect to the region R and generates the measurement information.

Then, the medical staff inputs the measurement registration command for registering the measurement value through the viewer screen 45 shown in FIG. 12. In response to the measurement registration command, the request issuer 38 issues the measurement registration request (S110). The measurement registration request is transmitted to the diagnosis support server apparatus 14 through the communication unit 28.

The diagnosis support server apparatus 14 receives the measurement registration request through the communication unit 28. The received measurement registration request is received or accepted by the registration request receiver 72 (S200). The registration request receiver 72 outputs the image-related information and the measurement information of the received measurement registration request to the lesion identifier 73. The registration request receiver 72 outputs the measurement information to the determination unit 74. The registration request receiver 72 outputs the image ID of the image-related information, the measurer-related information, and the measurement information to the registration unit 75. The registration request receiver 72 outputs the image ID of the image-related information to the setting unit 76.

The lesion identifier 73 retrieves the target image GT from the image list 21. The target image GT and the query image GQ, which is the examination image with which the image-related information of the measurement registration request is associated, have the same patient name, the same body site examined, the same orientation, and the same examination type. The lesion identifier 73 determines whether the lesion in the query image GQ is the same as the lesion in the target image GT (see S210). Based on a result of the determination, the lesion identifier 73 provides the lesion with the appropriate lesion ID. The lesion identifier 73 outputs the lesion ID to the determination unit 74, the registration unit 75, and the setting unit 76.

In S220, the setting unit 76 sets the threshold value for determining the presence or absence of the reliability of the measurement value of the major or minor axis length in the case where there are two or more measurement values with which the image ID, which is outputted from the registration request receiver 72, of the query image GQ and the lesion ID, which is outputted from the lesion identifier 73, are associated. For example, the threshold value is the standard deviation of the measurement values of the major or minor axis length, which are registered in the measurement list 23, with which the image ID of the query image GQ and the lesion ID, which is outputted from the lesion identifier 73, are associated. The threshold value is outputted to the determination unit 74.

Then the determination unit 74 determines the presence or absence of the reliability of the measurement value (in this example, the major axis length and/or the minor axis length) of the measurement information received from the registration request receiver 72 (S230). The determination unit 74 outputs the determination result to the registration unit 75.

The determination unit 74 calculates the reliability index to determine the presence or absence of the reliability of the measurement value. The reliability index is, for example, the absolute value (|the average value−the measurement value|), that is, the absolute value of the difference between the average value of the measurement values with which the image ID of the query image GQ registered in the measurement value list 23 and the lesion ID, which is outputted from the lesion identifier 73, are associated and the measurement value, which is outputted from the registration request receiver 72, of the query image GQ. The determination unit 74 compares the reliability index with the threshold value to determine the reliability of the measurement value.

As described above, the average value of the measurement values registered in the measurement value list 23 is calculated. Based on the average value, the reliability index is calculated. The reliability of the measurement value is determined based on the comparison between the calculated reliability index and the threshold value (e.g. the standard deviation or the like of the measurement values registered in the measurement value list 23). In the case where the measurement value with respect to the lesion in the query image GQ is close to the measurement values registered in the measurement value list 23 and within the range of variation of the measurement values registered in the measurement value list 23, the measurement value with respect to the lesion in the query image GQ is determined to be reliable. In the case where the measurement value with respect to the lesion in the query image GQ deviates from the measurement values registered in the measurement value list 23 and is outside the range of variation of the measurement values registered in the measurement value list 23, the measurement value with respect to the lesion in the query image GQ is determined to be unreliable.

The registration unit 75 registers the image ID, the measurer-related information, and the measurement information, which are outputted from the registration request receiver 72, and the determination result, which is outputted from the determination unit 74, in association with each other in the measurement value list 23 (see S240).

The measurement information and the determination result are registered in association with each other, so that the reliable measurement value is easily distinguished from the unreliable ones in the case where the region R is extracted two or more times and the measurement values are measured two or more times with respect to the same lesion in the same examination image. It is easy to refer to the reliable measurement value in performing the consultation, the treatment, or the statistical analysis.

The medical staff operates the client terminal apparatus 13 and inputs the information delivery command through the delivery request screen 60 shown in FIG. 13. In response to the information delivery command, the request issuer 38 issues the information delivery request for the delivery of the diagnostic support information (S150, see FIG. 27). The information delivery request is transmitted to the diagnosis support server apparatus 14 through the communication unit 28.

The diagnosis support server apparatus 14 receives the information delivery request through the communication unit 28. The information delivery request is received or accepted by delivery request receiver 77 (S250). The patient ID contained in the information delivery request is outputted to the program controller 78.

The program controller 78 generates the diagnostic support information of the patient with the patient ID contained in the information delivery request (S260). The diagnostic support information comprises the measurer-related information, the measurement information, the determination result, the medical data contained in the EMR, and the like. The diagnostic support information is outputted to the output unit 79.

In S270, the output unit 79 outputs the diagnostic support information through the communication unit 28 to the client terminal apparatus 13, which sent the information delivery request.

As illustrated in S160, the client terminal apparatus 13 receives the diagnostic support information through the communication unit 28. The received diagnostic support information is outputted to the program controller 37. The program controller 37 generates the list display screen 90 (see FIG. 22) and the integrated display screen 110 (FIG. 24) and the GUI controller 36 displays the list display screen 90 and/or the integrated display screen 110 on the display 29A. The medical staff refers to the screens 90 and 110 to perform the consultation and the treatment of the patient.

The list display screen 90 displays the cells 95, in each of which the text information 96 is displayed. The text information 96 shows the measurement values of the major and minor axis lengths, the name of the medical staff, and the name of the viewer program 35. The display state of the cell 95 is changed according to the determination result, so that the cell 95 with the reliable measurement values is distinguished from the cell 95 with the unreliable measurement values. Which measurement value is measured by which medical staff or by using which viewer program 35 and which measurement value is determined to be reliable or unreliable by the determination unit 74 are seen at a glance on the list display screen 90.

The list display screen 90 displays the line graph 103. The line graph 103 is drawn based on the measurement values that are determined to be reliable by the determination unit 74 and shows the chronological changes in the measurement values. The line graph 103 enables the doctor to perform the consultation and the treatment while referring to the reliable measurement values.

The lesion ID is corrected by the drag and drop operation of the cell 95. In case the lesion identifier 73 made an error in identifying the lesion, the error is corrected easily.

The integrated display screen 110 displays medical information (e.g. the vital signs, the result of laboratory test, and the like) in addition to the measurement values. The integrated display screen 110 allows comprehensive determination of the state of the patient. The integrated display screen 110 displays the line graph 119. The line graph 119 is drawn based on the measurement values that are determined to be reliable by the determination unit 74 and shows the chronological changes in the measurement values. The line graph 119 enables the doctor to perform the consultation and the treatment while referring to the reliable measurement values.

In the first embodiment, the client terminal apparatus 13 generates the list display screen 90 and the integrated display screen 110 based on the diagnostic support information from the diagnosis support server apparatus 14. Instead, the diagnosis support server apparatus 14 may generate the list display screen 90 and the integrated display screen 110. The client terminal apparatus 13 may allow viewing the integrated display screen 110 only. Viewing the list display screen 90 may be restricted. For example, only the administrators (or supervisors) of the medical facility may be allowed to view the list display screen 90 through the diagnosis support server apparatus 14.

In the first embodiment, the measurement registration request is transmitted and received through the network 15. Instead, the administrator of the medical facility may manually input the various types of information included in the measurement registration request to the diagnosis support server apparatus 14. In this case, the client terminal apparatus 13 may not necessarily be connected to the diagnosis support server apparatus 14 through the network 15.

In the first embodiment, the terminal ID, the staff ID, and the program ID are described as the examples of the measurer-related information. The measurer-related information may include at least one of the terminal ID, the staff ID, or the program ID. Note that the measurer-related information may include a department to which the medical staff belongs, specialism of the medical staff, or length of service of the medical staff.

In the first embodiment, the standard deviation (o) of the measurement values is set as the threshold value in the case where there are two or more measurement values of the major or minor axis length with which the image ID, which is outputted from the registration request receiver 72, of the query image GQ and the lesion ID, which is outputted from the lesion identifier 73, are associated. Instead, standard deviation×2 (2σ) or standard deviation×3 (3σ) may be set as the threshold value. Alternatively, the threshold value may be calculated by multiplying the standard deviation by a coefficient (e.g. 0.5 or 1.5) other than a positive integer.

In the first embodiment, the measured major axis length and the measured minor axis length are described as the examples of the measurement values whose presence or absence of the reliability is to be determined. Instead, the presence or absence of reliability may be determined for the size-related measurement value (e.g. the volume, the area, or the like), the pixel-value-related measurement value, or the shape-related measurement value other than the measured major axis length and the measured minor axis length.

### Second Embodiment

In the first embodiment, in the case where the number of the measurement value (the major axis length or the minor axis length) with which the image ID, which is outputted from the registration request receiver 72, of the query image GQ and the lesion ID, which is outputted from the lesion identifier 73, are associated is 0 or 1, the determination is performed by the comparison with the measurement value contained in the definitive diagnosis information. In this case, however, there is a time lag between the diagnostic imaging and the pathologic diagnosis, so that the determination of the reliability takes time.

In this embodiment, in the case where the number of the measurement value (the major axis length or the minor axis length) with which the image ID, which is outputted from the registration request receiver 72, of the query image GQ and the lesion ID from the lesion identifier 73 are associated is less than a predetermined lower limit number, the determination unit 74 determines that the measurement value with respect to the lesion in the query image GQ is unreliable regardless of its value.

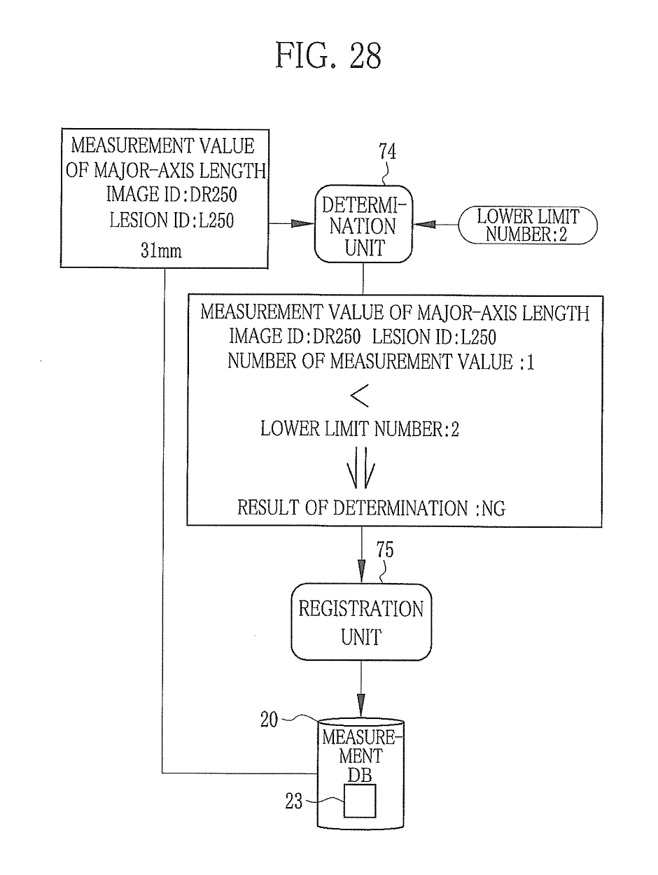

In an example illustrated in FIG. 28, the image ID of the query image GQ is “DR250”. The lesion ID from the lesion identifier 73 is “L250”. There is only one measurement value (the major-axis length) “31 mm” registered in the measurement information associated with the image ID “DR250” and the lesion ID “L250” in the measurement value list 23. The lower limit number of the measurement values is “2”. In this case, the determination unit 74 determines that the measurement value (the major axis length) of the query image GQ is unreliable because the number of the measurement value (the major axis length) associated with the image ID “DR250” and the lesion ID “L250” is “1”, which is less than the lower limit number “2”.

In this case, at the time the number of the measurement values of the major or minor axis length registered in the measurement value list 23 is greater than or equal to the lower limit number, the setting unit 76 calculates the standard deviation of the measurement values of the major or minor axis length. The determination unit 74 redetermines the reliability based on the standard deviation used as the threshold value. Thereby the determination is made without waiting for the pathologic diagnosis.

In this case, all the measurement values may be determined to be unreliable in a period in which the definitive diagnosis information is not obtained and the number of the measurement values registered in the measurement value list 23 is less than the lower limit number. As a result, the line graphs 103 and 119, which are drawn based on the measurement values determined to be reliable by the determination unit 74, may become inadequate. To avoid this, the measurement values to be registered in the measurement value list 23 may be temporarily and unconditionally determined to be reliable. At the time the number of the measurement values registered in the measurement value list 23 is greater than or equal to the lower limit number, the determination unit 74 may redetermine the reliability of the measurement values based on the standard deviation used as the threshold value. In the case where the measurement values temporarily determined to be reliable are used to draw the line graphs 103 and 119, a mark or sign, which indicates the temporary determination, is displayed for the line graphs 103 and 119.

### Third Embodiment

In the measurement value list 23, the measurer-related information and the determination result are registered in association with each other. With the use of the measurement value list 23, the total number (the sum) of the measurements performed by each measurer (e.g. each medical staff or each viewer program 35) is calculated and the sum of the number of times the determination unit 74 determined that the measurement value is unreliable (hereinafter referred to as the number of “NG”s) is calculated. A percentage (hereinafter referred to as the NG percentage) of the determination unit 74 determining that the measurement value is unreliable is calculated by dividing the number of “NG”s by the total number of the measurements.

Among the measurement values associated with the same image ID and the lesion ID, it is considered that the measurement value measured by the measurer with a relatively high NG percentage is more deviated from the rest than the measurement value measured by the measurer with a relatively low NG percentage. In the case where the reliability index is calculated based on the average value of the measurement values registered in the measurement value list 23 as described in the first embodiment (e.g. in the case where the reliability index is calculated as the absolute value (|average value−measurement value|) of the difference between the average value of the measurement values, with which the image ID of the query image GQ and the lesion ID outputted from the lesion identifier 73 are associated, and the measurement value, which is outputted from the registration request receiver 72, with respect to the lesion in the query image GQ), the average value is calculated based on the measurement values including the measurement value measured by the measurer with the relatively high NG percentage. The measurement value measured by the measurer with the relatively high NG percentage affects the average value, making the determination result incorrect.

In this embodiment, the reliability index is calculated after excluding the measurement value(s) measured by the measurer with the NG percentage exceeding a predetermined upper limit value. Alternatively, a percentage of contribution of the measurement value(s), measured by the measurer with the NG percentage exceeding the predetermined upper limit value, to the reliability index may be reduced.

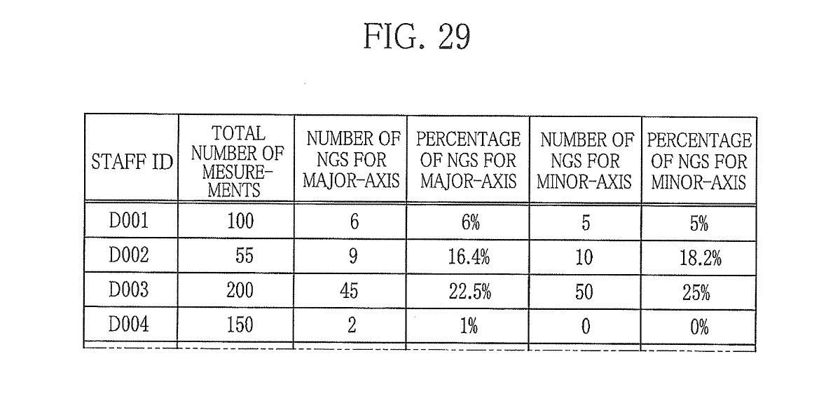

A list in FIG. 29 shows the total number of the measurements performed by each staff ID (medical staff), and the number of “NG”s and the NG percentage for each staff ID in measuring (or calculating) the measurement values of the major or minor axis length. The total number of the measurements and the number of “NG”s are calculated based on the measurement value list 23. The list in FIG. 29 shows that the medical staff with the staff ID “D004” has the lowest NG percentages (1% and 0%) in measuring the major and minor axis lengths and hence the best results. The medical staff with the staff ID “D003” has the highest NG percentages (“22.5%” and “25%”) in measuring the major and minor axis lengths and hence the worst results.

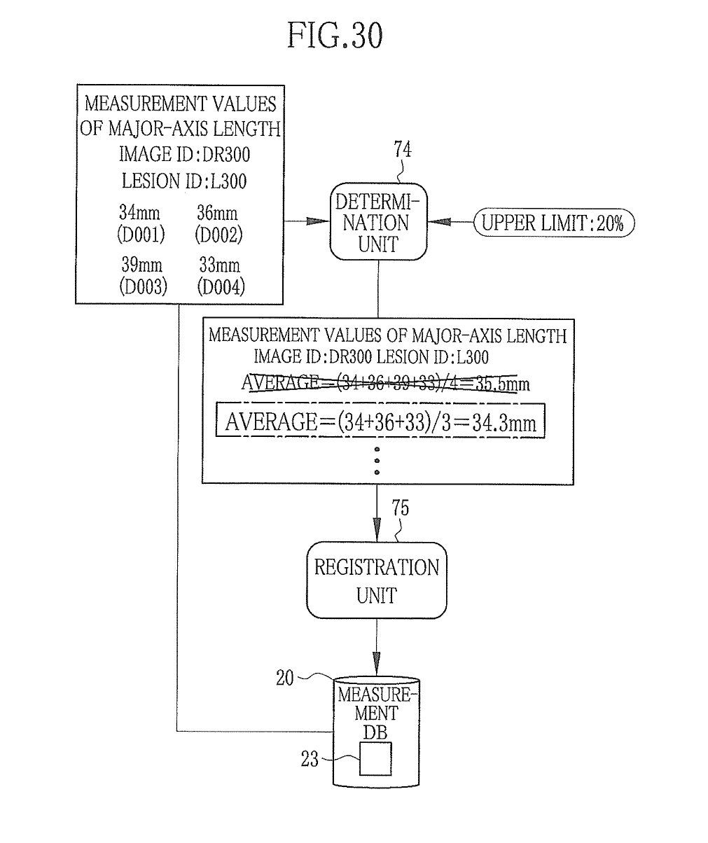

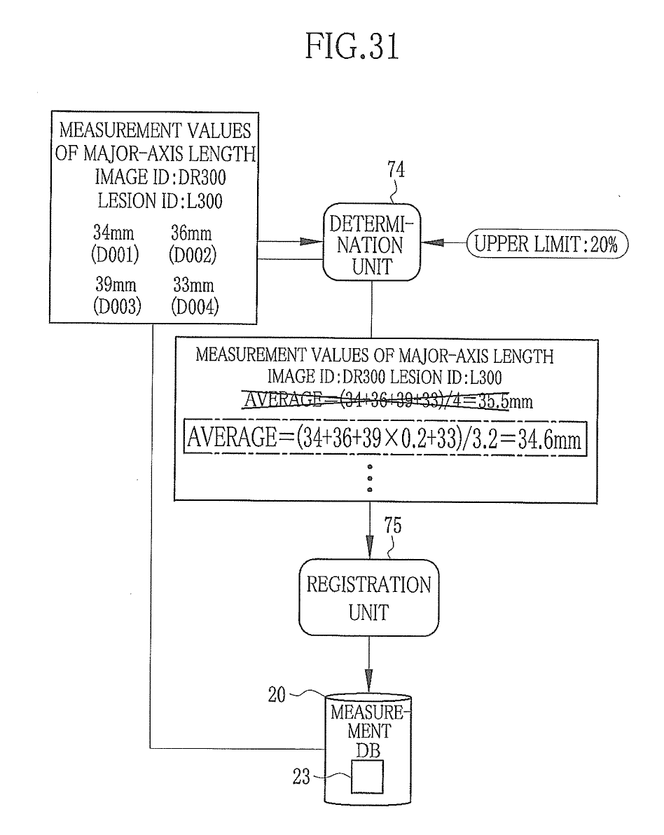

In the examples illustrated in FIGS. 30 and 31, the image ID of the query image GQ is “DR300”. The lesion ID provided by the lesion identifier 73 is L300”. Four measurement values of the major axis length “34 mm”, “36 mm”, “39 mm”, and “33 mm” are registered in association with the image ID “DR300” and the lesion ID “L300” in the measurement information in the measurement value list 23. The staff ID in parentheses below the measurement value represents the measurer who measured the measurement value. For example, the measurement values “34 mm”, “36 mm”, “39 mm”, and “33 mm” are measured by the medical staffs with the staff IDs “D001”, “D002”, “D003”, and “D004”, respectively.

For example, in the case where the upper limit value is “20%”, the determination unit 74 excludes the measurement value “39 mm” measured by the measurer (that is, the medical staff ID with the staff ID “D003”) with the NG percentage “22.5%” (see FIG. 29), which is higher than the upper limit value “20%”. The determination unit 74 calculates the average value of the three remaining measurement values (see a mathematical expression surrounded by the alternate long and short dashed lines in FIG. 30) to calculate the reliability index.

Alternatively, the determination unit 74 may multiply the measurement value “39 mm”, which is measured by the medical staff with the medical staff ID “D003”, by, for example, 0.2 and then sum the measurement values. The average value is calculated by dividing the sum of the measurement values by 3.2 (see a mathematical expression surrounded by the alternate long and short dashed lines in FIG. 31). Thereby a negative effect of the measurement value measured by the measurer with the NG percentage higher than or equal to the upper limit value on the reliability index is completely eliminated (see FIG. 30) or reduced (see FIG. 31). As a result, correctness of the determination result is ensured.

Note that the list shown in FIG. 29 may be displayed in the display 29A of the client terminal apparatus 13 to prompt the measurer having the NG percentage higher than or equal to the upper limit value to pay attention or improve. The NG percentage may be calculated by the summation of the number of the NGs on a terminal ID by terminal ID basis or on a program ID by program ID basis. The reliability index is calculated after excluding or reducing the percentage of contribution of the measurement value measured by the client terminal apparatus 13 or the viewer program 35 with the NG percentage higher than or equal to the upper limit value. The upper limit value may be changed in accordance with a unit for calculating the NG percentage. For example, the upper limit value may be set to 20% in the case where the NG percentage is calculated for each medical staff. The upper limit value may be set to 10% in the case where the NG percentage is calculated for each viewer program 35.

In the case where the standard deviation is calculated as the threshold value, the measurement value(s) of the measurer with the NG percentage higher than or equal to the predetermined upper limit value may be excluded from the calculation or the percentage of the contribution of the measurement value(s) to the calculation may be reduced.

### Fourth Embodiment

In the case where the number of the measurements of the major axis length or the minor axis length, with which the image ID, which is outputted from the registration request receiver 72, of the query image GQ and the lesion ID from the lesion identifier 73 are associated, is two or more as described in the first embodiment, the determination unit 74 performs the determination before the definitive diagnosis since there is a time lag between the diagnostic imaging and the pathologic diagnosis. In the case where the measurement value in the definitive diagnosis information is the same or substantially the same as the measurement value determined to be reliable by the determination unit 74 before the definitive diagnosis, the determination result is regarded as correct. However, in the case where the measurement value in the definitive diagnosis information is the same or substantially the same as the measurement value determined to be unreliable by the determination unit 74 before the definitive diagnosis, the determination result is regarded as incorrect and needs correction.

In this embodiment, the determination result obtained before the definitive diagnosis is redetermined after the definitive diagnosis and based on the measurement value contained in the definitive diagnosis information. In other words, the determination result is corrected in accordance with the definitive diagnosis information.

In FIG. 32, the definitive diagnosis information records the image ID, the lesion ID, and the measurement value(s) (the measurement value of the major axis length and the measurement value of the minor axis length in an example shown in FIG. 32). The determination unit 74 acquires the definitive diagnosis information from the EMR list 22.

Based on the definitive diagnosis information, the determination unit 74 redetermines the reliability of the measurement value registered in the measurement value list 23. For example, the determination unit 74 calculates a difference between the measurement value in the definitive diagnosis information and the measurement value registered in the measurement value list 23. In the case where the difference is less than or equal to a predetermined threshold value, the determination unit 74 determines that the measurement value registered in the measurement value list 23 is reliable. In the case where the difference is greater than the threshold value, the determination unit 74 determines that the measurement value registered in the measurement value list 23 is unreliable.

FIG. 32 illustrates the example in which the determination unit 74 redetermines the reliability of the measurement values (the measurement values of the major axis length and the measurement values of the minor axis length) with which the image ID “DR400” and the lesion ID “L400” are associated. In the definitive diagnosis information, the measurement value of the major axis length is “39 mm” and the measurement value of the minor axis length is “25 mm”. Before the acquisition of the definitive diagnosis information, the measurement values “35 mm” and “34 mm” of the major axis length and the measurement values “20 mm” and “21 mm” of the minor axis length are determined to be “OK (reliable)”. The measurement value “40 mm” of the major axis length and the measurement value “26 mm” of the minor axis length are determined to be “NG (unreliable)”.

A threshold value is used for a comparison with a difference between the measurement value in the definitive diagnosis information and the measurement value registered in the measurement value list 23. Here, the threshold value is set to “1 mm”, for example. In this case, the difference between the measurement value (the major axis length “39 mm”) in the definitive diagnosis information and the measurement value (the major axis length “35 mm”) registered in the measurement value list 23 is greater than the threshold value “1 mm”. The difference between the measurement value (the major axis length “39 mm”) in the definitive diagnosis information and the measurement value (the major axis length “34 mm”) registered in the measurement value list 23 is greater than the threshold value “1 mm”. The difference between the measurement value (the minor axis length “25 mm”) in the definitive diagnosis information and the measurement value (the minor axis length “20 mm”) registered in the measurement value list 23 is greater than the threshold value “1 mm”. The difference between the measurement value (the minor axis length “25 mm”) in the definitive diagnosis information and the measurement value (the minor axis length “21 mm”) registered in the measurement value list 23 is greater than the threshold value “1 mm”. Hence, after the acquisition of the definitive diagnosis information, the determination results for the above-described measurement values (the measurement values “35 mm” and “34 mm” of the major axis length and the measurement values “20 mm” and “21 mm” of the minor axis length) are changed to “NG (unreliable)”.

On the other hand, the difference between the measurement value “40 mm” of the major axis length registered in the measurement value list 23 and the measurement value “39 mm” of the major axis length in the definitive diagnosis information is less than or equal to the threshold value “1 mm”. The difference between the measurement value “26 mm” of the minor axis length registered in the measurement value list 23 and the measurement value “25 mm” of the minor axis length in the definitive diagnosis information is less than or equal to the threshold value “1 mm”. Hence the determination results for the measurement value “40 mm” of the major axis length and the measurement value “26 mm” of the minor axis length are maintained as “OK (reliable”).

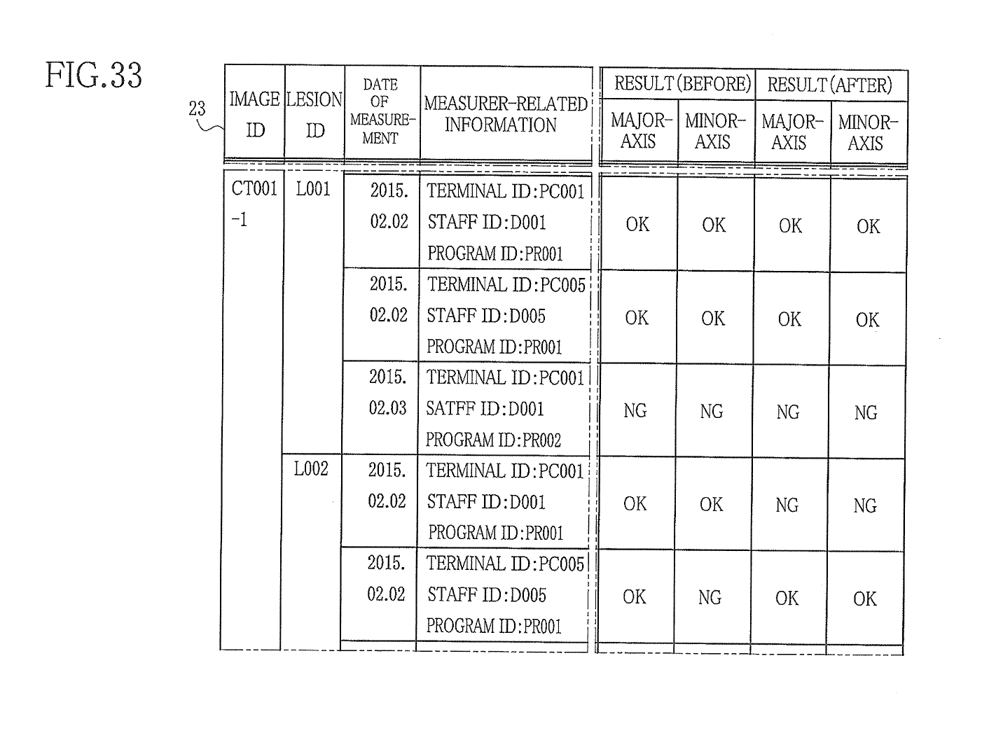

The registration unit 75 registers a result (which may also referred to as the determination result) of the redetermination, which is performed by the determination unit 74 after the acquisition of the definitive diagnosis information, in the measurement value list 23. As illustrated in FIG. 33, the measurement value list 23 is provided with an item “determination results after the acquisition of the definitive diagnosis information (abbreviated as “result (after)” in the drawing)” in addition to an item “determination results before the acquisition of the definitive diagnosis information (abbreviated as “result (before)” in the drawing)”. Thus, the determination results obtained before and after the acquisition of the definitive diagnosis information are registered in association with the respective measurement values.

As described above, the determination result obtained before the acquisition of the definitive diagnosis information is redetermined and corrected based on the definitive diagnosis information. Thereby the result of the definitive diagnosis is reflected on the determination result. The determination is changed from “NG (unreliable)” to “OK (reliable)” in the case where the measurement value determined to be unreliable before the definitive diagnosis turns out to be correct after the definitive diagnosis.

### Fifth Embodiment

Like the measurement values measured by the measurer having the relatively high NG percentage, which is described in the third embodiment, it is considered that the measurement value determined to be unreliable before the definitive diagnosis is highly deviated from the rest of the measurement values that are associated with the same image ID and the same lesion ID. Hence the measurement value determined to be unreliable before the definitive diagnosis is a deviation from the measurement values registered in association with the same image ID and the same lesion ID. The measurer that measured the measurement value determined to be unreliable before the definitive diagnosis is a minority among the measurers. In case the measurement value determined to be unreliable before the definitive diagnosis turns out to be reliable after the definitive diagnosis, the measurement values determined to be reliable before the definitive diagnosis, which are measured by the majority of the measurers, may be incorrect. In other words, the measurers that measured the measurement values determined to be reliable before the definitive diagnosis (that is, the majority of the measurers) may have incorrectly extracted the region R or incorrectly measured the measurement value and an immediate improvement is necessary.

In this embodiment, in the case where the measurement value determined to be unreliable before the acquisition of the definitive diagnosis information is redetermined to be reliable based on the definitive diagnosis information as described in the fourth embodiment, a warning informs that the determination has been changed.

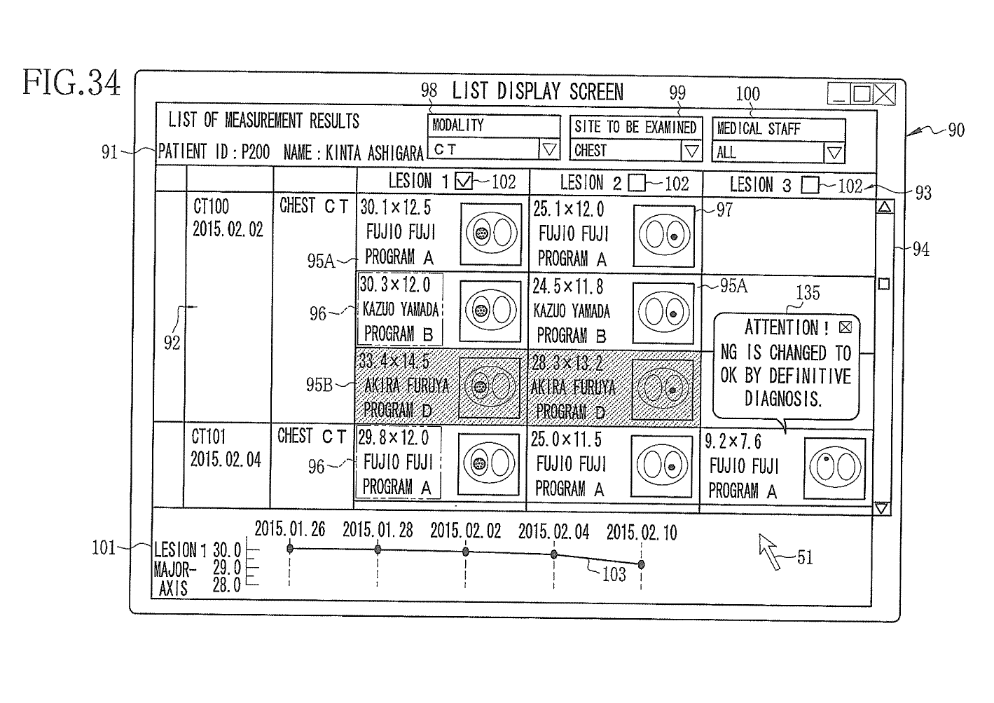

FIG. 34 illustrates an example of the warning. A popup balloon 135 is displayed for the cell 35 that displays the measurement value determined to be unreliable before the acquisition of the definitive diagnosis information and then redetermined to be reliable based on the definitive diagnosis information. The popup balloon 135 displays a warning message (e.g. “Attention! The determination result has been changed from NG to OK, based on the definitive diagnosis information”) describing or indicating that the determination has been changed (overturned). The display of the warning prompts the majority of the medical staffs to improve the extraction of the region R and/or the measurement of the measurement values and thereby contributes to the improvement of the reliability of the measurement values.

The warning message informs that the determination has been changed (overturned). The warning message may be sent to the majority of the medical staffs by broadcasting via emails or displayed on a screen that is viewed only by administrators (or supervisors) of the medical facility.

Note that the NG percentage (the percentage of the “NG (no good or unreliable)”) described in the third embodiment may be calculated based on the determination result that is obtained after the acquisition of the definitive diagnosis information.

There is a variety of hardware configuration of the computer that constitutes the client terminal apparatus 13 or the diagnosis support server apparatus 14. For example, for the purpose of improving capacity and reliability, the diagnosis support server apparatus 14 may be composed of two or more server computers separated from each other as the hardware. More specifically, one of the server computers may carry out the functions of the registration request receiver 72, the lesion identifier 73, the determination unit 74, the registration unit 75, and the setting unit 76. One of the server computers may carry out the functions of the delivery request receiver 77, the program controller 78, and the output unit 79. The client terminal apparatus 13 may carry out the functions of the lesion identifier 73 and the determination unit 74, and the diagnosis support server apparatus 14 may carry out the functions of the registration unit 75.

As described above, the hardware configuration of the computer may be changed as necessary in accordance with required performance with respect to capacity, safety, reliability, or the like. The application programs (e.g. the viewer program 35, the operation program 70, the diagnosis support program 71, and the like) may be backed up or distributed and stored in two or more storage devices, to ensure safety and reliability.

The above embodiments describe the medical information system 2 constructed in one medical facility, by way of example. The diagnosis support server apparatus 14 is used in one medical facility. Instead, the diagnosis support server apparatus 14 may be used by two or more medical facilities.

In the above embodiments, the client terminal apparatus 13 disposed in one medical facility is communicably connected to the diagnosis support server apparatus 14 through the LAN and the diagnosis support server apparatus 14 provides the client terminal apparatus 13 with the various functions in accordance with the various requests from the client terminal apparatus 13. To make the diagnosis support server apparatus 14 available to two or more medical facilities, the diagnosis support server apparatus 14 may be communicably connected through a WAN (Wide Area Network) such as the Internet or a public communication network to the client terminal apparatuses 13 disposed in the medical facilities. The diagnosis support server apparatus 14 receives the requests from the client terminal apparatuses 13 disposed in the medical facilities and provides the client terminal apparatuses 13 with the various functions through the WAN. Note that, in the case where the WAN is used, it is preferred to construct a VPN (Virtual Private Network) or to use a communication protocol (e.g. HTTPS (Hypertext Transfer Protocol Secure) or the like) with a high security level.

In this case, the diagnosis support server apparatus 14 may be installed in and managed by a data center or one of the medical facilities. The data center may be managed by an independent company.

In the case where the diagnosis support server apparatus 14 is available to the medical facilities and the diagnosis support server apparatus 14 generates the list display screen 90 and the integrated display screen 110, the diagnosis support server apparatus 14 delivers the list display screen 90 and the integrated display screen 110 in, for example, XML (Extensible Markup Language) data format for web distribution, which is described by a markup language such as XML, to the client terminal apparatuses 13. Based on the XML data, the client terminal apparatus 13 reproduces and displays the list display screen 90 and the integrated display screen 110 on the web browser. Note that another data description language such as JSON (JavaScript (registered trade mark) Object Notation) may be used instead of the XML.

The aspects of the present invention are not limited to the above embodiments and may adopt various types of configuration so long as they are within the scope of the present invention. For example, the image data DB 18, the EMR DB 19, and the measurement DB 20 may be provided separately as described in the above embodiments or integrated into one database. The measurement value may include a diameter, a radius, position coordinates of a center or a barycenter, in addition to or instead of those illustrated in FIG. 5. The above-described embodiments and various modifications may be combined in various combinations as necessary.

What is claimed is:

1. A measurement value management apparatus comprising:
a determination unit configured to perform determination of presence or absence of reliability of two or more measurement values obtained by two or more measurements of the measurement values with respect to a lesion in an examination image, the measurement value representing a feature of the lesion; and
a registration unit configured to register the measurement value in association with a result of the determination in a data storage unit.

2. The measurement value management apparatus according to claim 1, wherein the determination unit calculates a reliability index and performs the determination based on a result of a comparison between the reliability index and a threshold value, the reliability index quantitatively representing the reliability of each of the measurement values.

3. The measurement value management apparatus according to claim 2, wherein the determination unit calculates the reliability index based on an average value of the measurement values.

4. The measurement value management apparatus according to claim 3, further comprising a setting unit configured to set the threshold value based on standard deviation of the measurement values.

5. The measurement value management apparatus according to claim 3, wherein the determination unit determines that the measurement values are unreliable in a case where the number of the measurement values is less than a predetermined lower limit number.

6. The measurement value management apparatus according to claim 3, wherein the registration unit registers measurer-related information in association with the measurement values and the results of the determination, the measurer-related information being information related to a measurer, the measurer performed the measurement, and
the determination unit excludes the measurement value measured by the measurer whose percentage of the measurement values determined to be unreliable is higher than or equal to a predetermined upper limit value and calculates the reliability index, or the determination unit reduces a percentage of contribution of the measurement value measured by the measurer whose percentage of the measurement values determined to be unreliable is higher than or equal to the predetermined upper limit value, to the calculation of the reliability index.

7. The measurement value management apparatus according to claim 6, wherein the measurer-related information includes at least one of measurer identification information for identifying the measurer, measurement apparatus identification information for identifying a measurement apparatus that performed the measurement, or measurement program identification information for identifying a measurement program that performed the measurement.

8. The measurement value management apparatus according to claim 1, further comprising an output unit configured to output the measurement value and the result of the determination.

9. The measurement value management apparatus according to claim 8, wherein a list display screen is generated, the list display screen displaying the measurement values and the results of the determination in a list.

10. The measurement value management apparatus according to claim 9, wherein the list display screen displays a graph based on the measurement values that are determined to be reliable by the determination unit, the graph showing chronological changes in the measurement values.

11. The measurement value management apparatus according to claim 8, wherein the output unit outputs medical data of a patient in addition to the measurement values.

12. The measurement value management apparatus according to claim 11, wherein an integrated display screen is generated, the integrated display screen displaying the measurement values and the medical data.

13. The measurement value management apparatus according to claim 12, wherein the integrated display screen displays a graph based on the measurement values that are determined to be reliable by the determination unit, the graph showing chronological changes in the measurement values.

14. The measurement value management apparatus according to claim 1, wherein the determination unit acquires definitive diagnosis information of the lesion, and the determination unit performs the determination before the acquisition of the definitive diagnosis information and redetermines the determination based on the definitive diagnosis information after the acquisition of the definitive diagnosis information.

15. The measurement value management apparatus according to claim 14, wherein a warning that the determination has been changed is informed in a case where the measurement value determined to be unreliable by the determination made before the acquisition of the definitive diagnosis information is redetermined to be reliable by the determination made after the acquisition of the definitive diagnosis information.

16. The measurement value management apparatus according to claim 1, wherein the measurement value includes size-related measurement value, the size-related measurement value being related to size of a region of the lesion.

17. A method for operating a measurement value management apparatus comprising the steps of:
determining presence or absence of reliability of two or more measurement values obtained by two or more measurements of the measurement values with respect to a lesion in an examination image, the measurement value representing a feature of the lesion; and
registering the measurement value in association with a result of the determination in a data storage unit.

18. A measurement value management system comprising a measurement apparatus for performing measurement of a measurement value with respect to a lesion in an examination image and a measurement value management apparatus for managing the measurement value, the measurement value representing a feature of the lesion, the measurement value management system comprising:
a determination unit configured to perform determination of presence or absence of reliability of the two or more measurement values obtained by the two or more measurements with respect to the lesion in the examination image, the measurements being performed by the measurement apparatus; and
a registration unit configured to register the measurement value in association with a result of the determination in a data storage unit.
